(19) United States
(12) Patent Application Publication
(10) Pub. No.: US 2022/0266185 A1
(43) Pub. Date: Aug. 25, 2022

(54) Housing for receiving contaminated airflow from a clothes dryer or from a building's interior, constructed for filtering and recycling thru an interior piping system or disposing out to a building's exterior and comprising a safety mechanical shutdown system of the clothes dryer

(71) Applicant: Wayne Edward Bailey, Fredericksburg, VA (US)

(72) Inventor: Wayne Edward Bailey, Fredericksburg, VA (US)

(21) Appl. No.: 17/300,900

(22) Filed: Dec. 13, 2021

Related U.S. Application Data
(60) Provisional application No. 63/207,330, filed on Feb. 24, 2021.

(51) Int. Cl. B01D 46/46; B01D 46/00; B01D 46/62; B01D 46/12; B01D 46/44; D06F 58/20; F24F 8/10; F24F 13/22; F24F 13/10; F24F 11/33; F24F 11/89; F24F 7/007

(52) U.S. Cl. CPC B01D 46/46; B01D 46/0031; B01D 46/0041; B01D 46/62; B01D 46/12; B01D 46/446; B01D 46/448; D06F 58/20; F24F 8/10; F24F 13/222; F24F 13/10; F24F 11/33; F24F 11/89; F24F 7/007; B01D 2279/50; B01D 2279/35; F24F 2007/001

(57) ABSTRACT

Listed are some of this invention's unique features for producing a healthier home and a safer clothes dryer vent within the same housing system, which may be installed within a typical wall system or as a free-standing unit in a laundry room.

Included are two airflow receiving ports that accepts airflow from a clothes dryer or optionally from a house's interior rooms and two airflow exhaust ports that discharge the same airflow into an exhaust pipe to the outside or optionally into the building interior as recycled airflow.

A drainage device removes water derived from condensate which forms in the exhaust pipe and otherwise flows back into the housing.

Two (2) receiving ports and the two (2) exiting ports combine to provide four (4) combinations of airflow management.

The choice of which of the four (4) airflow ports are activated for airflow passage is subject to a selection from a control system which contains switches for the desired airflow management thru the housing.

Additionally, an exhaust system constructed to select airflow destinations, first destination, airflow can be directed to exit to the building's outside atmosphere or second destination, airflow can be directed to exit into an interior duct system for recycling of the filtered airflow.

Additionally, the control system contains monitors and sensors to indicate unsafe temperatures, air pressure changes or filter blockage within the housing.

A shutdown mechanism within the control system stops the airflow exhaust fan and stops the clothes dryer to provide an additional measure of safety.

Included in the invention is a multi-filter filtration system that includes filters that block lint particulate from a clothes dryer and block indoor pollutants comprising pre-filters, True HEPA filters, with activated carbon filters and air cleaners to meet EPA Indoor Air Quality Standards and MERV Ratings.

A multi-speed airflow exhaust fan moves airflow in thru the receiving ports, thru the multi-filters and out thru the exiting ports. Additionally, within the housing, access openings with removable windows provide internal inspections and accessibility.

In conclusion the elements of this invention combine to improve the efficiency and safety of a clothes dryer's exhaust system and improve the indoor air quality of a home or commercial building.

### SUMMARY

This invention has particular application to homes and other dwellings allowing homeowners, architects, builders and contractors greater leeway in designing more efficient utility room combinations.

Clothes dryers may be positioned for best use of floor space while providing a higher degree of fire safety and air purification within the house.

In accordance with the present invention there are multiple primary objects of the invention.

A primary object of this invention is for components of this invention to be within a housing, comprising a substantially open lower compartment and a substantially closed upper compartment.

Another primary object of this invention is an airflow fan constructed to move airflow into the housing thru one or another ports, thru a filter assembly constructed for removing particulate and pollutants and for moving the airflow out of the housing thru one of multiple ports.

Another primary object of this invention is for the filter assembly constructed to remove excess lint produced by a clothes dryer's exhaust which may otherwise enter a clothes dryer's venting pipe.

Another primary object of the invention is for the filter assembly to remove pollutants from interior household air for recycling as filtered and purified air or exited to the outside atmosphere.

Another primary object of this invention are multiple receiving ports for receiving airflow from either a clothes dryer or from a house interior and multiple exiting ports for exiting filtered airflow to an exterior atmosphere or to recycle the airflow into the house's interior atmosphere as selected thru an electric control system.

Another primary object of the invention is the electrical control system constructed to activate dampers to open and close the receiving and exiting ports to direct airflow passage thru the housing.

Another primary object of this invention is the electric control system constructed to receive signals from sensers to direct an emergency shutdown of the clothes dryer and the airflow fan when conditions warrant.

Another primary object of this invention is a removable airflow filter assembly comprising multiple filter screens constructed for removing particulate from clothes dryer exhaust and removing pollutants from household contaminated air within the housing and constructed to prevent falling condensate from entering the clothes dryer.

Another primary object of this invention is a condensate separator for segregating the exhaust airflow from the falling condensate/water and channeling the falling condensate/water through a disposal pipe and thru a sewer gas water trap for disposal and for preventing the water from flowing back into the housing and into the clothes dryer.

Another primary object of this invention is the multispeed airflow fan communicating with the control system with an on/off switch and emergency shutdown wired for safety and efficiency. Another primary object of this invention are access openings for maintenance with removable viewing windows installed for an airtight seal.

Another primary object of this invention is to provide a control system constructed for receiving signals from sensers, for activating airflow receiving and exiting port dampers to direct airflow, for signaling the clothes dryer and airflow fan to shutdown operations as warranted, and for monitoring and recording interior airflow conditions.

Additionally, a remote-control device communicates with the control system for remote activation of the control system.

Another primary object of this invention is to provide containment of the clothes dryer's flexible exhaust pipe within a lower storage compartment of the housing with a moveable retaining gate for securing the flexible exhaust pipe in multiple non-kinking positions for safe storage and efficient connections to the clothes dryer exit pipe. Another primary object of this invention is to construct all components to be sized to accommodate 100% or more of airflow volume and velocity produced by the clothes dryer.

Another primary object of this invention is to provide multi branch exhaust pipe system constructed for exiting the airflow out of the building thru one branch and exiting the airflow into a HVAC Ductwork or into a dedicated pipe for whole house airflow distribution, subject to selection of an operator.

To the accomplishment of the foregoing and related ends, the invention, then, comprises the features here. The present invention in after fully describe and particularly pointed out in the claims, the following description and the annexed drawings setting forth in detail curtain illustrative embodiments of the invention, these being indicative, however, of but some of the various ways in which the principals of the invention may be employed. It is a further object of the invention to provide improved elements and arrangements thereof for the purposes described which is inexpensive, dependable and fully effective in accomplishing its intended purposes.

These and other objects of the present invention will become readily apparent upon further review of the following specifications and drawings.

### REFERENCES CITED

Ser. No. 15/530,561 Bailey, Wayne (self).

This Bailey invention does not address an airflow fan, an emergency clothes dryer shutdown system, and multiple airflow receiving ports.
U.S. Pat. No. 9,605,869 Bailey, Wayne (self). This Bailey invention does not address an airflow receiving port constructed to selectively receive airflow from a building's interior space
U.S. Pat. No. 9,140,461 Bailey, Wayne (self). This Bailey invention does not address an airflow receiving port constructed to selectively receive airflow from a building's interior space
63,207,330 Bailey, Wayne (self) Provisional to this patent application, Feb. 24, 2021.
U.S. Pat. No. 3,487,624 Tignanelli Gerald.

This Tignanelli invention does not address separation of falling condensate from dryer produced lint within a clothes dryer vent system and the separate disposal of each.
U.S. Pat. No. 3,999,304 Doty, Edward E. The Doty invention does not address separation of falling condensate from dryer produce lint within a clothes dryer vent system and the separate disposal of each.
U.S. Pat. No. 4,338,731 Shames, Sidney.

This Shames invention does not address separating falling condensate from incoming lint within a clothes dryer vent system and the separate disposal of each.
U.S. Pat. No. 4,434,564 Braggins, John.

This Braggins invention does not address separating falling condensate from incoming lint within a clothes dryer vent system and the separate disposal of each.
U.S. Pat. No. 4,969,276 Walsh, Robert.

This Welsh invention does not address separating falling condensate from incoming lint within a clothes dryer vent system and the separate disposal of each.
U.S. Pat. No. 6,189,228 Schuette, Lyle.

This Schuette invention does not address separation of falling condensate from dryer produced lint within a clothes dryer vent system and the separate disposal of each.
2002/0023368 Beaumont, Bart.

This Beaumont invention does not address separating falling condensate from incoming lint within a clothes dryer vent system and the separate disposal of each.
2011/0167662 Dittmer, Lothar.

This Dittmer invention does not address separation of falling condensate from dryer produced lint within a clothes dryer vent system and the separate disposal of each.

### DESCRIPTION OF THE REFERENCED NUMERALS

Throughout the following specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive sense.

1. Housing.

The housing 1, having a substantially open lower compartment 2, and a substantially closed upper compartment 3. The housing 1, receives airflow 25, from a flexible airflow vent duct 17, airflow 25, continues thru an airflow receiving adapter 19, and thru a clothes dryer airflow receiving port 19-1, and thru a receiving airflow channel 26, into a receiving airflow distribution device 41, or optionally, subject to positioning of a rotatable damper door 19-2, airflow 25 is received through a building's interior airflow receiving port 19-4 into the receiving airflow distribution device 41.

From the receiving airflow distribution device 41, airflow 25 is directed through a removable airflow filter assembly 28, into and thru an airflow exhaust fan 46, and into an exiting airflow distribution device 42, subject to positioning of the rotatable damper door 19-2, airflow 25, is expelled thru either a building's exterior airflow exiting port 44, to an exterior atmosphere, or optionally, expelled thru a building's interior airflow exiting port to a building's interior 47. The housing 1, has a bottom wall of housing 4, left side wall of housing 5, right side wall of housing 6, rear wall of housing 7, top wall of housing 8, and housing attachment flanges 9, with attachment holes of housing flange 10.

Additionally, both rotatable damper doors 19-2, are activated by the rotatable damper actuator 19-3.

Additionally, illustrated is the control system 52, which comprises; 52-1, 52a, 52b, 52c, 52d, 52e, 52f, and 53, 54, 55, 56, 57, 58, 59, and 60.

2. Substantially open lower compartment.

The substantially open compartment 2, within the housing 1, contains the airflow flexible vent duct 17, which attaches to a Clothes Dryer CD on the receiving end and connects to an airflow receiving adapter 19, on the exit end.

The airflow flexible vent duct 17 is secured in the substantially open lower compartment 2, by a hinged barrier in closed position 12, which has hinged barrier adjustable cross bars 14 for securing the airflow flexible vent duct 17, Additionally, a moisture drain trap 23, and moisture disposal hose 24, are located within the substantially open lower compartment 2.

3. Substantially closed upper compartment.

The substantially closed upper compartment 3, within the housing 1, is enclosed by a front wall of substantially closed upper compartment 11, and contains an airflow receiving adapter 19, receiving airflow channel 26, first airflow directional vane 27, removable airflow filter assembly 28, exhaust airflow channel 37, second airflow directional vane 38, exiting airflow distribution device 42, airflow exhaust pipe connector 43, building's exterior airflow exiting port 44, moisture drain channel 48, airflow exhaust pipe 45, airflow exhaust fan 46, moisture drip edge 49, sloped basin shelf 21, returning moisture drain 22, which connects to the moisture drain trap 23, located within the substantially open compartment 2.

Additionally located within the substantially closed upper compartment 3, are openable access openings 39, removable viewing windows 40, control system 52, removable airflow filter assembly 28, and a substantially closed upper compartment floor/substantially open lower compartment ceiling 20.

4. Bottom wall of housing.

The bottom wall of housing 4, serves as base of housing 1, and is connected to the rear wall of housing 7, left side wall of housing 5, and right side wall of housing 6.

5. Left side wall of housing.

The left side wall of housing 5, is connected to the bottom wall of housing 4, rear wall of housing 7, and top wall of housing 8 and connected to the front wall of substantially closed upper compartment 11.

6. Right side wall of housing.

The right side wall of housing 6, is connected to the bottom wall of housing 4, rear wall of housing 7, top wall of housing 8 and front wall of substantially closed compartment 11.

7. Rear wall of housing.

The rear wall of housing 7, is connected to the bottom wall of housing 4, connected to the top wall of housing 8, connected to the left side wall of housing 5, and connected to the right side of housing 6.

8. Top wall of housing.

The top wall of housing 8, is connected to the rear wall of housing 7, left side wall of housing 5, right side wall of housing 6, and front wall of substantially closed compartment 11.

9. Housing attachment flanges.

The housing attachment flange 9, is connected to the left side wall of housing 5, right side wall of housing 6, and top wall of housing 8.

The housing attachment flange 9, is turned at a right angle to the housing walls and extended outward for securing the housing 1, to other support types.

10. Attachment holes of housing flanges

The attachment holes of housing flange 10, of the housing attachment flange 9, are for receiving attachment devices for securing the housing 1, to a building's framework.

11. Front wall of substantially closed upper compartment.

The front wall of substantially closed upper compartment 11, which is removable, covers and contains the substantially closed upper compartment 3, sealing it from air and moisture leakage with openings for the removable airflow filter assembly 28, openable access openings 39, removable viewing windows 40, receiving airflow distribution device 41, exiting airflow distribution device 42, and control system 52.

12. Hinged barrier in closed position.

The hinged barrier in closed position 12, is located and attached to one of the side walls of housing 5&6 of the substantially open lower compartment 2, for retaining and efficiently positioning the flexible airflow vent duct 17, within the substantially open compartment 2.

13. Hinged barrier in open position.

The hinged barrier in open position 13, allows access for general servicing and efficient placement of the flexible airflow vent duct 17, and for connecting the flexible airflow vent duct 17, to the airflow receiving adapter 19 located within the substantially closed upper compartment floor/substantially open lower compartment ceiling 20.

14. Hinged barrier adjustable cross bars.

The hinged barrier adjustable cross bars 14, allows accessibility for multiple positions for the flexible airflow vent duct 17 to be efficiently placed within the substantially open lower compartment 2, for maximum airflow 25, efficiency.

15. Barrier hinges.

The barrier hinges 15, are attached to one of the side walls of housing 5&6 and attached to the hinged barrier in closed position 12, for operating the hinged barrier in closed position 12 and hinged barrier in open position 13.

16. Hinged barrier control mechanism.

The hinged barrier control mechanism 16, is for operating the hinged barrier in closed position 12 and hinged barrier in open position 13.

17. Flexible airflow vent duct.

The flexible airflow vent duct 17, is a hollow enclosed conduit with the first end connected to a Clothes Dryer CD, and the second exit end connected to the airflow receiving adapter 19.

18. Vent knockouts, left, right and bottom walls.

The vent knockouts 18, may be located on the left side wall of housing 5, right side wall of housing 6, bottom wall of housing 4, and rear wall of housing 7, and is located for entry and connection of the flexible airflow vent duct 17, into the housing 1.

19. Airflow receiving adapter.

The airflow receiving adapter 19, is located within the substantially closed upper compartment floor/substantially open lower compartment ceiling 20, and is circular on the first incoming end to connect with the round end of the flexible airflow vent duct 17, and is shaped for Transition on the second exit end to the receiving airflow channel 26, so as to accommodate 100% or greater of airflow 25, flowing through the flexible airflow vent duct 17, and meet the measurement and dimension requirements of the housing 1.

19-1. Clothes dryer airflow receiving port.

The clothes dryer airflow receiving port 19-1, accepts airflow 25, from the receiving airflow channel 26, and directs the airflow 25 into the receiving airflow distribution device 41.

The clothes dryer airflow receiving port 19-1, in the open position as a result of the rotatable damper door 19-2, being in the position of closing the building's interior airflow receiving port 19-4, within the receiving airflow distribution device 41.

The airflow 25, is drawn thru the clothes dryer airflow receiving port 19-1, when the rotatable damper door 19-2, has been positioned to close the building's interior airflow receiving port 19-4.

19-2. Rotatable damper door.

The rotatable damper door 19-2, is located within the receiving airflow distribution device 41 and the rotatable damper door 19-2 is located within the exiting airflow distribution device 42.

Within the receiving airflow distribution device 41, the rotatable damper door 19-2 is located and hinged between the clothes dryer airflow receiving port 19-1, and the building's interior airflow receiving port 19-4.

Within the exiting airflow distribution device 42, the rotatable damper door 19-2, is located and hinged between the building's exterior airflow exiting port 44, and the building's interior airflow exiting port 47,

The rotatable damper door 19-2 is operatable manually, or by the rotatable damper door actuator 19-3, which receives commands from the control system 52.

19-3. Rotatable damper door actuator

The rotatable damper door actuator 19-3, receives commands from the control system 52. The rotatable damper door actuator 19-3 operates the rotatable damper door 19-2 by mechanical means and may be programed to operate with custom designed operational specifications to meet multiple airflow 25, requirements.

The rotatable damper door actuator 19-3, can operate the rotatable damper door 19-2 of the receiving airflow distribution device 41, independently or in conjunction with the rotatable damper door 19-2 of the exiting airflow distribution device 42, to produce multiple combinations of receiving airflow 25, thru the receiving airflow distribution device 41, and produce multiple combinations of expelling airflow 25, thru the exiting airflow distribution device 42, of the housing 1.

19-4. Building's Interior airflow receiving port.

The building's interior airflow receiving port 19-4, located within the receiving airflow distribution device 41, accepts airflow 25 directly from the building's space adjacent to the housing 1, and directs the airflow 25, into the receiving airflow distribution device 41.

The building's interior airflow receiving port 19-4, being in the open position as a result of the rotatable damper door 19-2, being in the position of closing the clothes dryer airflow receiving port 19-1, within the receiving airflow distribution device 41.

The building's airflow 25 is drawn thru the building's interior airflow receiving port 19-4, when the rotatable damper door 19-2, has been positioned to close the clothes dryer airflow receiving port 19-1.

20. Substantially closed upper compartment floor/substantially open lower compartment ceiling.

The substantially closed upper compartment floor/substantially open lower compartment ceiling 20, Located between the substantially open lower compartment 2, and the substantially closed upper compartment 3, for providing a separation wall of the substantially closed upper compartment 3. The substantially closed upper compartment floor/substantially open lower compartment ceiling 20, comprising openings for the airflow receiving adapter 19, and the returning moisture drain 22 and the electrical wiring from control system to clothes dryer 56. Additionally, the substantially closed upper compartment floor/substantially open lower compartment ceiling 20, serves as an airtight sealed bottom wall of the substantially closed upper compartment 3.

21. Sloped basin shelf.

The sloped basin shelf 21, is Located within the substantially closed upper compartment 3, and is positioned above the substantially closed upper compartment floor/substantially open lower compartment ceiling 20, for receiving returning condensate moisture derived from airflow exhaust pipe C, and for receiving moisture from the moisture weep holes 28g, and additionally receives moisture from the moisture drain channel 48, which derives returning condensate moisture derived from airflow exhaust pipe C, which originates from the airflow exhaust pipe 45. The sloped basin floor 21, is sloped downward from the frame of lower guide 30, downward to the returning moisture drain 22, to keep water from entering the flexible airflow vent duct 17.

22. Returning moisture drain.

The returning moisture drain 22, is located within the substantially closed upper compartment floor/substantially open lower compartment ceiling 20, with the upper receiving end located at the lowest point of the sloped basin shelf 21, for Receiving returning condensate moisture derived from airflow exhaust pipe C, from the sloped basin shelf 21, and for draining the condensate moisture out of the substantially closed upper compartment 3, into the moisture drain trap 23, which is located beneath the returning moisture drain 22.

23. Moisture drain trap.

The moisture drain trap 23, is connected to and beneath the returning moisture drain 22, to prevent entry of rising sewer gases which may derive from the moisture disposal hose 24.

The moisture drain trap 23, is designed to retain returning condensate moisture derived from upward airflow exhaust pipe C, in a looped “S” type or “P” type plumbing trap configuration and for blocking sewer gas passage through the moisture drain trap 23.

24. Moisture disposal hose.

The moisture disposal hose 24, connects to the moisture drain trap 23, on its receiving end and is connected to an outlet at the exit end for transporting returning moisture derived from upward airflow exhaust pipe C, which drains from the moisture drain trap 23 into a drain system.

25. Airflow.

The airflow 25, originates either from a clothes dryer CD, which is contaminated with excess clothes lint within extremely hot and extremely moist airflow 25, or the airflow originates from the building or household area and is contaminated with dust, mold spores, pet odors and household odors, viruses and other unhealthy air contaminates.

The airflow 25, is drawn into the receiving airflow distribution device 41, by the airflow fan 46, thru either the clothes dryer airflow receiving port 19-1, or thru the building's interior airflow receiving port 19-4, depending on the selected position of the rotatability damper door 19-2. The airflow 25, exits the receiving airflow distribution device 41, and is guided into and thru the removable airflow filter assembly 28, by the first airflow directional vane 27, the airflow 25, passes thru and is filtered by the removable airflow filter assembly 28, and the airflow 25, is guided by the second airflow directional vane 38, toward and into the airflow fan 46, which pushes the airflow 25, into the exiting airflow distribution device 42.

The airflow 25 enters the exiting airflow distribution device 42, and is forced by the airflow fan 46, to exit thru either the building's exterior airflow exiting port 44 or to exit thru the building's interior airflow exiting port 47.

When the airflow 25 is exited thru the building's exterior airflow exiting port 44, from the exiting airflow distribution device 42, the airflow 25 enters the exhaust airflow channel 37, and passes thru the airflow exhaust pipe connector 43, and is removed from the housing 1, thru the airflow exhaust pipe 45.

When the airflow 25 is exited thru the building's interior airflow exiting port 47, from the exiting airflow distribution device 42, directly into an adjacent space of the building as filtered airflow 25.

The selected position of the rotatable damper door 19-2, of the exiting airflow distribution device 42, directs the airflow 25 to either exit the building's interior airflow exiting port 47, or directs the airflow 25 to exit the building's exterior airflow exiting port 44.

The open and close positions of the rotatable damper door 19-2, is controlled by the rotatable damper door actuator 19-3, for selecting airflow 25, source and destination.

26. Receiving airflow channel (primary or alternate).

The receiving airflow channel 26, is located within the substantially closed upper compartment 3, connected at its receiving end to the airflow receiving adapter 19.

The hollow receiving airflow channel 26, receives airflow 25, from the airflow receiving adapter 19, and channels the airflow 25 into the receiving airflow distribution device 41.

27. First airflow directional vane.

The first airflow directional vane 27, is located within the substantially closed upper compartment 3, for redirecting up-flowing Airflow 25, derived from the lower distribution box 41.

The first airflow directional vane 27, guides the airflow 25, into the removable airflow filter assembly 28.

The curvature shape of the first airflow directional vane 27, rounds out the sharp corner of the substantially closed upper compartment 3, to produce a more efficient airflow into the removable airflow filter assembly 28.

28. Removable airflow filter assembly.

The removable airflow filter assembly 28, Includes airflow filter assembly frame 28a, first group of multiple filter screens 28b, second group of multiple filter screens 28c, multiple filter screen surrounds 28d, airflow filter assembly hinges 28e, and airflow sensers 28f.

The removable airflow filter assembly 28, is designed to be removable for cleaning and filter replacements. Additionally, the removable airflow filter assembly 28, prevents returning moisture deriving from upward airflow exhaust pipe C, from entering the receiving airflow distribution device 41, additionally, the removable airflow filter assembly 28, simultaneously filters particulate and contamination from entering the exiting airflow distribution device 42.

28a. Airflow filter assembly frame.

The airflow filter assembly frame 28a, supports the airflow sensers 28f, and airflow filter assembly hinges 28e, which are hinged to open for cleaning the first and second group of multiple airflow filter screens 28b& 28c, when removed from the substantially closed upper compartment 3, are in closed position when inserted into the removable airflow filter assembly, frame upper guide 29, and into the sloped floor of lower guide 32 of the substantially closed upper compartment 3.

Additionally, the airflow filter assembly frame 28a, contains moisture weep holes 28g, for draining away any returning condensate moisture derived from airflow exhaust pipe C, which may enter and flow from the removable airflow filter assembly 28.

28b. First group of multiple filter screens.

The first group of multiple filter screens 28b, is located within the removable airflow filter assembly 28, and is located adjacent to the second group of multiple filter screens 28c. and is attached to the filter screen surrounds 28d, which is attached to the airflow filter assembly frame 28a.

The removable airflow filter assembly 28 receives airflow 25 from the receiving airflow distribution device 41.

The first group of multiple filter screens 28b, comprising any or all or a combination of the following filter designs;

fiberglass-mesh filters, electrostatically charged filters, TRUE HEPA filters, activated carbon charcoal filters, extended media filters, electronic filters with electric power supply 51, ultraviolet filters, ion filters and custom designed filters and filter combinations.

The custom designed filters for the first group of multiple filter screens 28b, may be selected and combined from existing generic or non-generic filter designs, sized and constructed to comply with this invention's specifications.

28c. Second group of multiple filter screens.

The second group of multiple filter screens 28c, is located within the removable airflow filter assembly 28, and is located adjacent to the first group of multiple filter screens 28b and is attached to the multiple filter screen surrounds 28d. which is attached to the removable airflow filter assembly frame 28a.

The removable airflow filter assembly 28, receives airflow 25, from the receiving airflow distribution device 41.

The second group of multiple filter screens 28c, comprising any or all or a combination of the following filter designs;

fiberglass-mesh filters, electrostatically charged filters, TRUE-HEPA filters, activated carbon charcoal filters, extended media filters, electronic filters with electric power supply 51, ultraviolet filters, ion filters custom designed filters and filter combinations.

The custom designed filters for the second group of multiple filter screens 28c, may be selected and combined from existing generic or non-generic filter designs, sized and constructed to comply with this invention's specifications.

28d. Multiple filter screen surrounds.

The multiple filter screen surrounds 28d consist of a structure for attaching and supporting the first group of multiple filter screens 28b, and the second group of multiple filter screens 28c. The multiple filter screen surrounds 28d, are connected to the airflow filter assembly frame 28a, with airflow filter assembly, hinges 28e, for folding together for inserting into the substantially closed upper compartment 3, and unfolding when removed for cleaning.

28e. Airflow filter assembly hinges.

The airflow filter assembly hinges 28e, connects the multiple filter screen surrounds 28d, to the airflow filter assembly frame 28a and allows the first group of multiple filter screens 28b, and the second group of multiple filter screens 28c, to be folded open for cleaning and folded closed for inserting into the airflow filter assembly frame upper guide 29, and into the sloped floor of lower guide 32, of the substantially closed upper compartment 3.

28f. Airflow sensers.

The airflow sensers 28f, are attached within the airflow filter assembly frame 28a, for quality control and airflow condition monitoring within the removable airflow filter assembly 28 and within the substantially closed upper compartment 3.

The airflow sensers 28f, communicates with the control system 52, for airflow 25, condition, quality and safety control.

28g. Moisture weep holes.

The moisture weep holes 28g, are located within the lower side of the airflow filter assembly frame 28a, of the removable airflow filter assembly 28, for receiving returning moisture derived from upward airflow exhaust pipe C, that may inadvertently flow back into the first and second group of multiple filter screens 28b & 28c, of the removable airflow filter assembly 28. The moisture weep holes 28g, drains the returning condensate moisture derived from airflow exhaust pipe C, into the sloped basin shelf 21, for disposal through the returning moisture drain 22.

29. Airflow filter assembly frame upper guide.

The airflow filter assembly frame upper guide 29, is located within the substantially closed upper compartment 3, for receiving and securing the airflow filter frame 28a, when it is inserted into its operational position inside the substantially closed upper compartment 3. The airflow filter assembly frame upper guide 29, works jointly with the sloped floor lower guide 32, to secure the airflow filter assembly frame 28a.

30. Frame of lower guide.

The frame of lower guide 30, is located within the substantially closed upper compartment 3, for receiving and securing the airflow filter assembly frame 28a, when it is inserted into its operational position inside the substantially closed upper compartment 3.

The sloped floor of lower guide 32 works jointly with the airflow filter assembly, frame upper guide 29, to secure the airflow filter assembly frame 28a.

Additionally, the airflow filter assembly, frame 28a, has a sloped floor of lower guide 32, tapered downward toward the returning moisture drain 22, to produce a fit of the sloped frame bottom wall 33, which allows the airflow filter assembly frame 28a, to be “keyed” into the airflow filter assembly frame upper guide 29 and sloped floor of lower guide 32.

31. Sloped lower guide.

The sloped lower guide 31, is tapered toward the moisture drain 22, on the exit side of the filter frame 28a, to serve as a fit of the sloped floor of lower guide 32, which matches with the Top of the sloped lower guide 31, to match with a sloped frame bottom wall 33, to insure proper placement of the airflow filter assembly frame 28a, within the airflow filter assembly frame upper guide 29 and sloped lower guides 31 and the frame of lower guide 30.

32. Sloped floor of lower guide.

The sloped floor of lower guide 32, is tapered to match the shape of the sloped frame bottom wall 33, and matches the sloped lower guide 31, resulting in a matching fit and positioning of the airflow filter assembly frame 28a, and insures proper insertion of the airflow filter assembly frame 28a, into the airflow filter assembly frame upper guide 29, and frame lower guide 30.

33. Sloped frame bottom wall.

The sloped frame bottom wall 33, matches the sloped floor of lower guide 32, to the sloped lower guide 31, which serves to provide a proper insertion and to secure placement of the airflow filter assembly 28a, into the airflow filter assembly frame upper guide 29, and frame of lower guide 30, within the substantially closed upper compartment 3.

34. Hinged barrier attachment.

The hinged barrier attachment 34, connects the hinged barrier in closed position 12, to the left side wall of housing 5, or the right side wall of housing 6.

35. Airflow deflector.

The airflow deflector 35, Is an airflow directional guide with its lower end connected to the filter frame lower guide 30, with its body projected upward and away from the removable airflow filter assembly 28, at about a 45-degree angle to direct airflow 25, upward into the exiting airflow distribution device 42.

Additionally, the airflow deflector 35, prevents airflow 25, from entering the moisture drain 22. Additionally, the upper end of the airflow deflector 35, is higher than the lower end of the second airflow directional vane 38, and the airflow deflector 35 diverts the airflow 25, upward before the airflow 25, reaches the lower end of the second airflow directional vane 38, and directs the airflow 25, past the lower end of the second airflow directional vane 38, thus, preventing the airflow 25, from entering the moisture drain 22.

The airflow deflector 35, is located between the lower end of the second airflow directional vane 38, and the airflow filter assembly frame 28a, to deflect airflow 25 upward before it reaches the opening at the moisture drip edge 49.

36. Alternate airflow directional vane.

The alternate directional vane 36, is installed in the upper side of the alternate airflow channel 37, when an airflow exhaust pipe connector 43, is installed in the substantially closed upper compartment floor/substantially open lower compartment ceiling 20, to allow alternate ports in a downward exit direction of the airflow exhaust pipe 45, configuration, thus resulting in a downward airflow direction.

37. Exhaust airflow channel, (primary or alternate).

The exhaust airflow channel 37, is hollow and is located in the substantially closed upper compartment of housing 3, on the exit side of the removable airflow filter assembly 28, located above and communicates with the exiting airflow distribution device 42, and located below and communicates with the airflow exhaust pipe connector 43.

The exhaust airflow channel 37, is a hollow tube which carries airflow 25, from the building's exterior airflow exiting port 44, thru the airflow exhaust pipe connector 43, into the airflow exhaust pipe 45.

38. Second airflow directional vane.

The second airflow directional vane 38, is located within the substantially closed upper compartment 3, for turning the latterly flowing airflow 25, leaving the removable airflow filter assembly 28, to an upward direction.

The lower end of the second airflow directional vane 38 extends below the airflow deflector 35, which is located between the lower end of the second airflow directional vane 38 and the lower end of the removable airflow filter assembly 28, resulting in the airflow deflector 35, blocking the airflow 25, from entering the returning moisture drain 22.

Additionally, the second airflow directional vane 38, does not reach all the way to the frame vertical side of lower guide 30, resulting in a moisture passageway at the lower end of the second airflow directional vane 38, which is adjacent to the moisture drip edge 49, which allows an open space for the returning condensate moisture deriving from airflow exhaust pipe C, to flow to the sloped basin floor 21, while preventing the entry of airflow 25, into the returning moisture drain 22.

39. Openable access openings.

The openable access openings 39, are located on the front wall of substantially closed compartment 11, and the openable access openings 39, are for entering the Substantially closed upper compartment of housing 3, for testing, cleaning and inspections.

The openable access openings 39, are enclosed with removable viewing windows 40, which provide an air-proof seal when installed.

40. Removable viewing windows.

The removable viewing windows 40, when installed, covers the openable access openings 39 with an air-tight seal.

The removable viewing windows 40, allow interior observation of the substantially closed upper compartment of housing 3, without requiring removal from the openable access openings 39. The removable viewing windows 40, are removable for interior inspections and maintenance of the substantially closed upper compartment of housing 3.

41. Receiving airflow distribution device.

The receiving airflow distribution device 41, located within the substantially closed upper compartment 3, receives airflow 25, thru the clothes dryer airflow receiving port 19-1, or receives airflow 25 thru the building's interior airflow receiving port 19-4 and expellees the airflow 25, toward the removable airflow tilter assembly 28.

The rotatable damper door 19-2, located within the receiving airflow distribution device 41, alternates movement between closing off the clothes dryer airflow receiving port 19-1 or alternately closing off the building's interior airflow receiving port 19-4, resulting in one of the two receiving ports being open to receive airflow 25, while the other receiving port is closed. Airflow 25, entering the clothes dryer airflow receiving port 19-1, of the receiving airflow distribution device 41, originates from a clothes dryer and flows thru the flexible airflow vent duct 17, and thru the airflow receiving adapter 19, and into the receiving airflow channel 26, and into the clothes dryer airflow receiving port 19-1, and into the receiving airflow distribution device 41. Airflow 25 is then expelled towards the removable airflow filter assembly 28. Airflow 25, entering the building's interior airflow receiving port 19-4, and into the receiving airflow distribution device 41, originates from building airflow 25, adjacent to the housing 1, and flows thru the building's interior airflow receiving port 19-4 and into the receiving airflow distribution device 41, airflow 25 is then expelled toward the removable airflow filter assembly 28.

The airflow 25, is moved thru the substantially closed upper compartment 3, by the airflow exhaust fan 4.

42. Exiting airflow distribution device.

The exiting airflow distribution device 42, located within the substantially closed upper compartment 3, receives airflow 25, from the airflow fan 46, which is located beneath the exiting airflow-distribution device 42.

The airflow fan 46 draws the airflow 25 thru the removable airflow filter assembly 28, thru the airflow exhaust fan 46, and sends the airflow 25, into the exiting airflow distribution device 42.

The airflow 25 received into the exiting airflow distribution device 42, is expelled thru the building's exterior airflow exiting port 44, or expelled thru the building's interior airflow exiting port 47.

The rotatable damper door 19-2, located within the exiting airflow distribution device 42, alternates between closing off the building's exterior airflow exiting port r 44, or alternately closing off the building's interior airflow exiting port 47, resulting in one of the two exit ports being open to expel airflow 25, while the other exit port is closed.

Airflow 25, exiting thru the building's exterior airflow exiting port 44, enters the exhaust airflow channel 37 and thru the airflow exhaust pipe connector 43, and thru the airflow exhaust pipe 45, to the outside atmosphere.

Airflow 25, exiting thru the building's interior exiting port 47, is forced into the building interior space as filtered clean airflow 25.

The airflow 25 is moved thru the substantially closed upper compartment 3, by the airflow exhaust fan 46.

43. Airflow exhaust pipe connector.

The airflow exhaust pipe connector 43, located at and through the top wall of housing 8, for connecting the exhaust airflow channel 37, to the airflow exhaust pipe 45.

The airflow exhaust pipe connector 43, is hollow and receives airflow 25, from the exhaust airflow channel 37, and serves as a connection and conduit between the exhaust airflow channel 37, and the airflow exhaust pipe 45, which is hollow for continued airflow 25 passage thru and out of the housing 1.

44. Building's exterior airflow exiting port.

The building's exterior airflow exiting port 44, is located within the exiting airflow distribution device 42, and serves as the passageway for airflow 25, to enter the exhaust airflow channel 37. The rotatable damper door 19-2, located within the exiting airflow distribution device 42, rotates from an open position to allow airflow 25, passage thru the building's exterior airflow exiting port 44, or rotates to a closed position to prevent airflow 25, passage thru the building's exterior airflow exiting port 44.

The building's exterior airflow exiting port 44, located within the exiting airflow distribution device 42, serves as a conduit between the exiting airflow distribution device 42, and the exhaust airflow channel 37.

44a. Manual damper door control mechanism.

The manual damper door control mechanism 44a, is for manually activating the open or closed position (up or down) of the rotatable damper door 19-2, located within the receiving airflow distribution device 41, and the exiting airflow distribution device 42.

44b. Damper door hinge.

The damper door hinge 44b, connects the rotatable damper door 19-2, to the receiving airflow distribution device 41, and connects the rotatable damper door 19-2 to the exiting airflow distribution device 42.

The damper door hinge 44b, provides a mechanism for the rotatable damper door 19-2 to rotate within the receiving airflow distribution device 41, and to rotate within the exiting airflow distribution device 42.

The damper door hinge 44b, allows the rotatable damper door 19-2, to rotate between the clothes dryer airflow receiving port 19-1, and the building's interior airflow receiving pore 19-4, within the receiving airflow distribution device 41.

The damper door hinge 44b, allows the rotatable damper door 19-2, to rotate between the building's exterior airflow exiting port 44, and the building's interior airflow exiting port 47, within the exiting airflow distribution device 42.

44c. Damper door air seal.

The damper door air seal 44c, prevents airflow 25, and moisture from leaking when the rotatable damper door 19-2 is in a closed position of a port.

44d. Open position of rotatable damper door.

The open position of rotatable damper door 44d, illustrates an example of the rotatable damper door 19-2, in an open position of a typical airflow 25, port.

The open position of rotatable damper door 44d, allows airflow 25, passage.

44c. Closed position of rotatable damper door.

The closed position of rotatable damper door 44e, illustrates an example of the rotatable damper door 19-2, in a closed position of a typical airflow 25 port.

The closed position of rotatable damper door 44e, disallows airflow 25, passage.

45. Airflow exhaust pipe.

The airflow exhaust pipe 45, is hollow and extends above the top wall of housing 8 and is positioned up-stream of the airflow exhaust pipe connector 43, for receiving and channeling exiting airflow 25 from the airflow exhaust pipe connector 43, which is located in the top wall of housing 8, into the wye diverter 45-3.

45-1 Extended exhaust pipe to exterior atmosphere.

The extended exhaust pipe to exterior atmosphere 45-1, is hollow and connects to one exit port of the wye diverter 45-3, constructed to carry airflow 25, to the exterior atmosphere.

45-2 Extended exhaust pipe to HVAC Ductwork.

The extended exhaust pipe to HVAC Ductwork 45-2, is hollow and connects to the other exit port of the wye diverter 45-3, constructed to carry airflow 25, to the HVAC Ductwork or to a designated duct system, for whole house recycling.

45-3 Wye Diverter.

The Wye Diverter 45-3 is hollow and constructed with one receiving port and two exiting ports which branch separately for providing two separate airflow exiting channels.

Within the wye diverter 45-3, is a damper door constructed for closing one of the two exiting ports to allow airflow 25, passage through the other exiting port which is in the open position. The position of the damper door is selected by the operator for directing the airflow 25, into the exit port of choice.

Connected to the wye diverter 45-3, receiving port is the exiting end of the airflow exhaust pipe 45, for receiving airflow 25, from the airflow exhaust pipe 45, into the wye diverter 45-3. which connects to the exiting end of the airflow exhaust pipe 45, for receiving airflow 25, Connected to one of the two exiting ports is the extended airflow pipe to exterior atmosphere 45-1, constructed to be hollow and carry airflow 25, derived from the wye diverter 45-3, and deliver the airflow 25 to the building's exterior.

Connected to the second exiting port is the extended airflow pipe to interior HVAC Ductwork 45-2, constructed to be hollow and carry airflow 25, derived from the wye diverter 45-3, and deliver the airflow 25, to the HVAC ductwork or to a dedicated duct system.

45-4 Airflow Damper.

The Airflow damper 45-4, located within the junction of the extended airflow pipe 45-2, and the HVAC Ductwork, constructed to regulate airflow within the HVAC. Ductwork and within the extended airflow pipe 45-2, and for preventing HVAC airflow from entering the extended airflow pipe 45-2, during non-operating periods of the airflow exhaust fan 46, located within the housing 1.

46. Airflow exhaust fan.

The airflow exhaust fan 46, located beneath the exiting airflow distribution device 42, within the substantially closed upper compartment 3.

Optionally, the airflow exhaust fan 46, draws airflow 25 thru the receiving airflow channel 26, thru the clothes dryer airflow receiving port 19-1 and into the receiving airflow distribution device 41.

Optionally, the airflow fan 46, draws airflow 25, thru the building's interior airflow receiving port 19-4, into the receiving airflow distribution device 41.

Continuing, the airflow exhaust fan 46, continues to draw the airflow 25 from the receiving airflow distribution device 41, thru the removable airflow filter assembly 28, thru the airflow fan 46, with the airflow 25 blown into the exiting airflow distribution device 42.

There are two options for the airflow 25, to exit the exiting airflow distribution device 42, the first option is for the airflow fan 46, to move airflow 25 thru the building's exterior airflow exiting port 44, and the second option is for the airflow fan 46, to move airflow 25, thru the building's interior airflow exiting port 47.

In the first option airflow 25 moved by the airflow exhaust fan 46, exits the exiting airflow distribution device 42, thru the building's exterior airflow exiting port 44, into the exhaust airflow channel 37, thru the airflow exhaust pipe connector 43, and into the airflow exhaust pipe 45, and into the wye diverter 45-3, and into either the extended airflow pipe to exterior atmosphere 45-1, or into the extended airflow pipe to interior HVAC Ductwork 45-2.

In the second option airflow 25, forced by the airflow exhaust fan 46, exists the exiting airflow distribution device 42, thru the building's interior airflow exiting port 47, into the building interior as recycled filtered air, free of particulate and contamination.

The airflow exhaust fan 46, is multi-speed and of axial fan design or of centrifugal fan design. And communicates with the control system 52.

47. Building's interior airflow exiting port.

The building's interior airflow exiting port 47, is located within the exiting airflow distribution device 42, and serves as the passageway for airflow 25, to be moved by the airflow exhaust fan 46, into the building interior atmosphere as filtered air, free of particulate and contamination. Airflow 25, is moved thru the building's interior airflow exiting port 47, by the airflow exhaust fan 46, when the building's exterior airflow exiting port 44, is closed by the rotatable damper door 19-2, thus having the building's interior airflow exiting port 47, in the open position.

48. Moisture Drain Channel.

The moisture drain channel 48, is a hollow tube located within the substantially closed upper compartment 3, that is attached at its upper end to the exhaust airflow channel 37, to receive and carry away returning condensate moisture derived from airflow exhaust pipe C, which develops within the airflow exhaust pipe 45.

The returning condensate moisture derived from airflow exhaust pipe C, is then disposed above the returning moisture drain 22, within the substantially closed upper compartment 3.

The moisture drain channel 48, serves to collect water that may be produced from condensate which can develop within the airflow exhaust pipe 45, and carry the collected water to the returning moisture drain 22.

49. Moisture drip edge.

The moisture drip edge 49, Is located at the lower tip of the second airflow directional vane 38, and located above the sloped basin shelf 21, and located at a lower point than the airflow deflector 35, and located behind the airflow deflector 35, resulting in the airflow deflector 35, being between the moisture drip edge 49, and the removable airflow filter assembly 28.

The position of the moisture drip edge 49, and relationship to the airflow deflector 35, allows returning condensate moisture derived from upward airflow exhaust pipe C, to drip downward into the sloped basin shelf 21, while preventing airflow 25, from entering the sloped basin shelf 21.

50. Alternate airflow exiting port.

The alternate airflow exit port 50, located within the housing 1, and located above and on the out-flow side of the airflow exhaust fan 46, to allow airflow 25, to be directed into an alternate location by blocking the same airflow 25 from entering the upward airflow exhaust pipe 45. The alternate airflow exit port 50, is an alternate location of the airflow exhaust pipe 45.

51. Electrical power supply.

The electric power supply 51, serves to provide electricity to the airflow exhaust fan 46, and to the electric filters located within the first and second group of multiple filter screens 28b & 28c, and to the control system 52.

The electrical power supply 51, which may be derived from the building electrical system to service the electrical requirements of all components of the housing 1.

The electrical power supply 51, includes but is not limited to wiring, panel boxes, brakers, transformers, remote-controls, surge protectors, and including the control system 52, included is an electrical grounding device and meets all UL safety requirements and meets all electrical requirements listed or not listed in this application.

52. Electrical control system.

The electrical control system 52, which is electrified to provide visual alerts, audible alerts and system shut-downs due to over-heating, blocked airflow, blocked filters, airflow inefficiencies and other safety issues within the housing 1, including but not limited to airflow vent blockage, interior over-heating and filter blockage or a combination of each.

Additionally, the electrical control system 52, provides a shut-off switch for turning off the airflow exhaust fan 46, and communicates with the clothes dryer CD, to turn off the clothes dryer CD, when safety issues are present such as an electrical short, over-heating and airflow blockage are present.

An electrical wiring loop comprises the following electrical connections.

The electrical control system 52, wired to the airflow exhaust fan 46, and wired to the electrical control system 52, and wired to the lower rotatable damper door actuator 19-3, and wired to the electrical control system 52, and wired to the upper rotatable damper door operating mechanism 19-3.

Additionally, electrical wiring connects the lower rotatable damper door actuator 19-3, to the upper rotational damper door actuator 19-3.

Additionally, the electrical control system 52, is wired to the electrical controls of the clothes dryer CD, electrical current flows back and forth thru the electric wires from the control system to clothes dryer 56, to direct an electrical shut-down of the clothes dryer CD, when conditions within the housing. 1, dictate.

Additionally, illustrated is the electrical control system 52, which comprises;

52-1. Monitor and alarm

The monitor and alarm 52-1 communicates with the electrical control system 52 and the airflow sensers 28f, to provide visual, recorded data and audible notification of conditions within the housing 1, and being within an electrical loop of the electrical control system 52.

52a. The ON/OFF control switch for activating and deactivating the airflow exhaust fan 46.

52b. The switch for activating the rotatable damper door 19-2 of the receiving airflow distribution device 41, to allow airflow. 25, to enter thru clothes dryer airflow receiving port 19-1, and for activating the rotatable damper door 19-2 of the exiting airflow distribution device 42, to allow same airflow 25, to exit thru the building's exterior airflow exiting port 44.

52c. A switch for activating the rotatable damper door actuator 19-3, of the rotatable damper door 19-2, of the receiving airflow distribution device 41, to allow airflow 25, to enter thru clothes dryer airflow receiving port 19-1, and for activating the rotatable damper door actuator 19-3, of the rotatable damper door 19-2, of the exiting airflow distribution device 42, to allow same airflow 25, to exit thru building's interior airflow exiting port 47.

52d. A switch for activating the rotatable damper door actuator 19-3, of the rotatable damper door 19-2, of the receiving airflow distribution device 41, to allow airflow 25, to enter thru building's interior airflow receiving port 19-4, and for activating the rotatable damper door actuator 19-3, of the rotatable damper door 19-2, of the exiting airflow distribution device 42, to allow same airflow 25, to exit thru the building's exterior airflow exiting port 44.

52e. A switch for activating the rotatable damper door actuator 19-3 of the rotatable damper door 19-2, of the receiving airflow distribution device 41, to allow airflow 25, to enter thru the building's interior airflow receiving port 19-4 and for activating the rotatable damper door actuator 19-3, of the rotatable damper door 19-2, to allow same airflow 25, to exit thru the building's interior airflow exiting port 47.

52f. A switch for activating the damper door within the wye diverter 45-3, for selecting which extended airflow pipe is to be active.

53. Electrical wiring from the electrical control system to the airflow exhaust fan.

The electrical wiring from the electrical control system 52, to the airflow exhaust fan 46, for electrical communication between the electrical control system 52, and the airflow exhaust fan 46.

54. Electrical wiring from the control system to the receiving and exiting rotatable damper door actuator.

The electrical wiring from the electrical control system 52, to the receiving and exiting rotatable damper door actuator 19-3, for electrical communication between the control system 52, and the receiving and exiting rotatable damper door actuator 19-3.

55. Electrical wiring from the receiving rotatable damper door actuator to the exiting rotatable damper door actuator.

The electrical wiring from the receiving rotatable damper door actuator 19-3, to the exiting rotatable damper door actuator 19-3, for electrical communication between the receiving rotatable damper door actuator 19-3 and the exiting rotatable damper door actuator 19-3.

56. Electrical wiring from the control system to the clothes dryer.

The electrical wiring from the control system 52, to the clothes dryer 56, for electrical communication between the control system 52, and the clothes dryer CD, for an electrical shutdown to the clothes dryer CD, as directed by the control system 52, in an emergency situation.

57. Remote control.

The remote control 57, communicates remotely with the control system 52, for data communications.

58. Electrical wiring from monitor and alarm to airflow sensers.

The electrical wiring from the monitor and alarm 52-1, to the airflow sensers 28f, for electrical communicating between the monitor and alarm 52-1, and the airflow sensers 28f.

59. Electrical wiring from the control system to the monitor and alarm.

The electrical wiring from the electrical control system 52, to the monitor and alarm 52-1, for communicating between the electrical control system 52, and the monitor and alarm 52-1.

60. Electrical wiring from electrical control system to airflow sensers.

The electrical wiring from the electrical control system 52, to the airflow sensers 28f, for communicating between the electrical control system 52, and the airflow sensers 28f.

C. Returning condensate moisture deriving from airflow exhaust pipe.

Moisture falling downward from the airflow exhaust pipe 45, is referred to as returning moisture derived from airflow exhaust pipe C.

As the returning moisture derived from upward airflow exhaust pipe C, which is condensate converting back to water within the airflow exhaust pipe 45, passes down through the airflow exhaust pipe connector 43, and flows into the exhaust airflow channel 37, the water is redirected into the moisture drain channel 48, and drains away thru the moisture drain channel 48, to be deposited at the returning moisture drain 22, for further disposal thru the moisture drain trap 23, and thru the moisture disposal hose 24.

CD. Clothes Dryer

The clothes dryer CD, which is outside the scope of this invention, is electrically wired to the electrical control system 52, within the housing 1, by the electrical wiring from control system to clothes dryer 56, to provide an emergency power shut-off of the clothes dryer CD, in the event of an electrical short, airflow blockage, overheating, blocked filters or airflow efficiencies issues or safety issues, arise within the housing, 1.

The clothes dryer CD, produces warm, moist, particulate laden air which can become condensate as the warm air meets cooler air in the airflow exhaust pipe 45, and the condensate converts to moisture and can drain back as returning moisture derived from upward airflow exhaust pipe C.

Without this invention a clothes dryer CD, which produces high temperature exhaust airflow with a high percentage of moisture content and lint particulate can produce major airflow venting problems, such as lint blockage, water blockage or a mixture of the two which produces a sludge in the vent system, resulting in airflow blockage, overheating and fires.

Additionally, vent blockage shortens the clothes dryer's life, reduces efficiency, produces higher energy cost and can support mold growth in the vent and laundry room, creating an unhealthy environment.

An estimated 2,900 clothes dryer fires in residential buildings are reported to U.S. fire departments each year and cause an estimated 5 deaths, and $35 million in property loss as reported by FEMA.

### DETAILED DESCRIPTION OF FIGURES

Throughout the following specific details are set forth in order to provide a more through understanding to persons skilled in the art. However, well known elements may not have been shown or described in detail to avoid unnecessarily obscuring the disclosure.

Accordingly, the description and drawings are to be regarded in an illustrative, rather than a restrictive sense.

These drawings illustrate airflow basically entering the left side of the cabinet and turning laterally thru the filter assembly into the right side of the cabinet and exiting in the upper right side within the cabinet, these illustrations show a left to right directional configuration, it should be noted that a mirrored right to left configuration is also an acceptable design.

This left to right cabinet illustration and an opposite right to left illustration are equally acceptable designs.

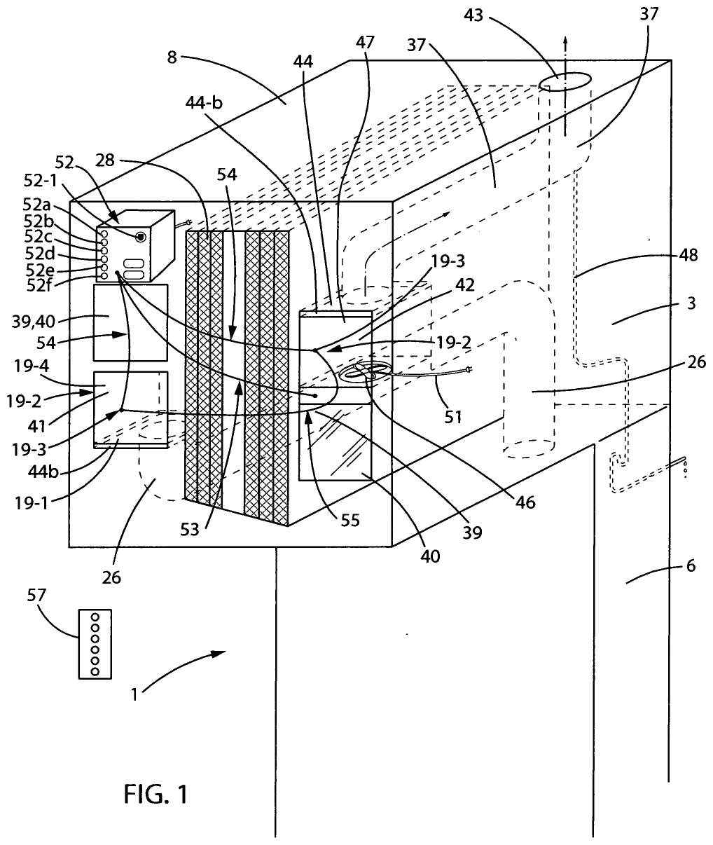

The preferred embodiment of the invention is shown in FIGS. 1 thru 20.

FIG. 1, illustrates a perspective view of the housing 1, comprising a substantially closed upper compartment 3, a clothes dryer airflow receiving port 19-1, building's interior airflow receiving port 19-4, a receiving airflow channel 26, and a receiving airflow distribution device 41, with a damper door hinge 44-b.

Additionally, comprising openable access openings 39, with removable viewing windows 40, which provides a means to enter and examine the interior of the substantially closed upper compartment 3.

Airflow 25 is received into the receiving airflow distribution device 41, thru either the clothes dryer airflow receiving port 19-1, or thru the building's interior airflow receiving port 19-4, subject to the position of the rotatable damper door 19-2, which is controlled by the rotatable damper door actuator 19-3.

Additionally, included is a control system 52, which provides real-time operations and diagnostics of the system within the housing 1.

Additionally, illustrated is the control system 52, which comprises; 52-1, 52a, 52b, 52c, 52d, 52e, 52f. and a remote control 57, for communicating with the control system 52, for distant input and 53, 54, 55, 56, 58, 59, and 60.

52-1. Monitor and alarm.

52a. Switch to activate On/Off electric power supply to the airflow exhaust fan.

52b. Switch to activate airflow received thru clothes dryer airflow receiving port and said airflow exiting out thru building's exterior airflow exiting port to the outside atmosphere.

52c. Switch to activate airflow received thru clothes dryer airflow receiving port and airflow exiting out thru building's interior airflow exiting port as recycled interior airflow.

52d. Switch to activate airflow received thru building's interior airflow receiving port and airflow exiting out thru building's exterior airflow exiting port to the outside atmosphere.

52e. Switch to activate airflow received thru building's interior airflow receiving port and airflow exited out thru building's interior airflow exiting port as recycled interior airflow.

52f. Blank switches for future additions.

53. Electrical wiring from control system to the airflow exhaust fan.

54. Electrical wiring from control system to receiving and exiting rotatable damper door actuators.

55. Electrical wiring from receiving rotatable damper door actuator to exiting rotatable damper door actuator.

56. Electrical wiring from control system to clothes dryer.

57. Remote control

58. Electrical wiring from monitor and alarm to airflow sensors.

59. Electrical wiring from control system to monitor and alarm.

60. Electrical wiring from control system to airflow sensers.

Additionally, the electrical control system 52, communicates with the remote control 57, for sending and receiving operational commands to the control system 52.

Additionally, included is the removable airflow filter assembly 28, which comprises a multi-filter airflow purification system.

Additionally, an airflow exhaust fan 46, with electric power supply 51, is located within the housing 1, for moving airflow 25, in thru the clothes dryer airflow receiving port 19-1, or in thru the building's interior airflow receiving port 19-4, and thru the receiving airflow distribution device 41, and thru the removable airflow filter assembly 28, and into the exiting airflow distribution device 42 and out thru the building's exterior airflow exiting port 44, or out thru the building's interior airflow exiting port 47.

Additionally, the airflow exhaust fan 46, constructed as a module unit for placement within a designated pocket and constructed for efficient removal and replacement and noninvasive transition within said housing 1.

The exiting airflow distribution device 42, has two exit ports, first is the building's exterior airflow exiting port 44, which directs airflow 25, into the exhaust airflow channel 37, and the other second exit port, is the building's interior airflow exiting port 47.

The selection between the building's exterior airflow exiting port 44, or the building interior airflow exiting port 47, for airflow 25, direction is dependent on the positioning of the rotatable damper door 19-2. The rotatable damper door 19-2 positioning is controlled by the rotatable damper door actuator 19-3.

When the Airflow 25, is directed thru the building's exterior airflow exiting port 44, by the positioning of the rotatable damper door 19-2, the airflow 25, enters the exhaust airflow channel 37, and continues thru the airflow exhaust pipe connector 43, into the airflow exhaust pipe 45, for removal into the outside atmosphere.

The building's exterior airflow exiting port 44, located within the exiting airflow distribution device 42, communicates with the exhaust airflow channel 37, which communicates with the airflow exhaust pipe connector 43, which communicates with the airflow exhaust pipe 45.

The moisture drain channel 48, communicates with the exhaust airflow channel 37; for accepting returning condensate moisture deriving from airflow exhaust pipe C, thus preventing the returning condensate moisture derived from airflow exhaust pipe C, from entering the receiving airflow distribution device 41.

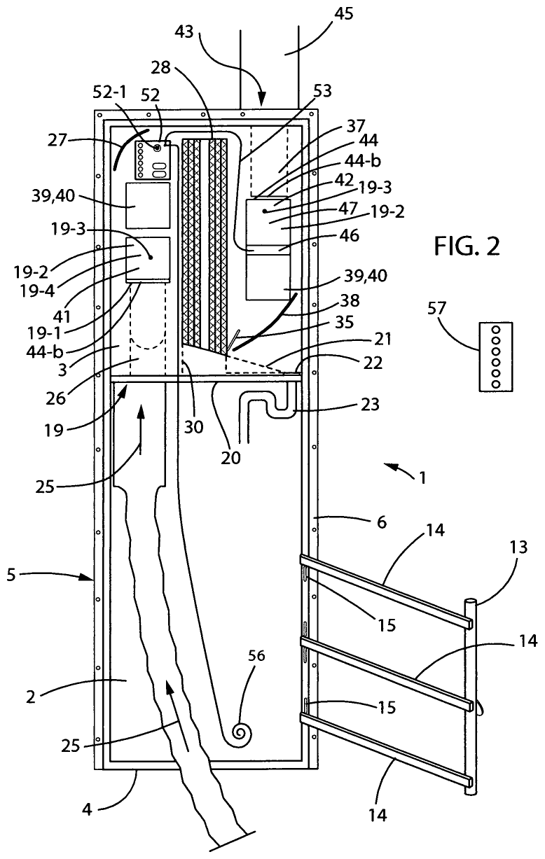

FIG. 2, illustrates a front view of the substantially closed upper compartment 3, of the housing 1. The airflow 25, is drawn thru the airflow receiving adapter 19, into the lower airflow channel 26, and into the receiving airflow distribution device 41.

The receiving airflow distribution device 41, contains two airflow receiving ports, first, the clothes dryer airflow receiving port 19-1, and second, the building's interior airflow receiving port 19-4.

Additionally, the receiving airflow distribution device 41, contains a rotatable damper door 19-2, which is manually or mechanically controlled to rotate by the rotatable damper door actuator 19-3, for rotating to close either the clothes dryer airflow receiving port 19-1 or for closing the building's interior airflow receiving port 19-4, resulting in the non-closed receiving port being open to receive airflow 25.

The airflow 25, being drawn thru the receiving airflow distribution device 41, by the airflow exhaust fan 46, passes thru the removable airflow filter assembly 28, and is drawn thru the airflow fan 46, into the exiting airflow distribution device 42, which contains two airflow exit ports, first, the building's exterior airflow exiting port 44, and second, the building's interior airflow exiting port 47.

Additionally, the exiting airflow distribution device 42, contains the rotatable damper door 19-2, which manually or mechanically rotates to close either the building's exterior airflow exiting port 44, or close the building's interior airflow exiting port 47, resulting in the non-closed exit port being open for exiting the airflow 25, out of the exiting airflow distribution device 42.

The airflow 25, exiting from the exiting airflow distribution device 42, thru the building's exterior airflow exiting port 44, continues into the exhaust airflow channel 37, and continues thru the airflow exhaust pipe connector 43, into the airflow exhaust pipe 45. and into the exterior atmosphere.

The airflow 25, exhausted from the exiting airflow distribution device 42, thru the building's interior airflow exiting port 47, is exited into the building interior atmosphere as filtered recirculated airflow.

Additionally, illustrated is the airflow deflector 35, which is the airflow 25, directional guide with its lower end connected to the frame of lower guide 30, with its body extending upward and away from the removable airflow filter assembly 28, for directing airflow 25 upward into the airflow exhaust fan 46, and into the exiting airflow distribution device 42.

Additionally, illustrated is the control system 52, which comprises; 52-1, 52a, 52b, 52c, 52d, 52e, 52f, 53, 54, 55, 56, 57, 58, 59, and 60.

52-1. Monitor and alarm.

52a. An On/Off control switch for activating and deactivating the airflow exhaust fan 46.

52b. A switch for activating the rotatable damper door actuator 19-3 of the receiving airflow distribution device 41, to allow airflow 25, in thru clothes dryer airflow receiving port 19-1, and for activating the rotatable damper door actuator 19-3, of the exiting airflow distribution device 42, to allow same airflow 25, out thru the building's exterior airflow exiting port 44.

52c. A switch for activating the rotatable damper door actuator 19-3, of the receiving airflow distribution device 41, to allow airflow 25, in thru clothes dryer airflow receiving port 19-1, and for activating the rotatable damper door actuator 19-3, of the exiting airflow distribution device 42, to allow same airflow 25, out thru building's interior airflow exiting port 47.

52d. A switch for activating the rotatable damper door actuator 19-3, of the receiving airflow distribution device 41, to allow airflow 25, in thru building's interior airflow receiving port 19-4, and for activating the rotatable damper door actuator 19-3, of the exiting airflow distribution device 42, to allow same airflow 25, out thru the building's exterior airflow exiting port 44.

52e. A switch for activating the rotatable damper door actuator 19-3 of the receiving airflow distribution device 41, to allow airflow 25 in thru the building's interior airflow receiving port 19-4, and for activating the rotatable damper door actuator 19-3, to allow same airflow 25, out thru the building's interior airflow exiting port t 47, for interior recycling.

52f. A switch for activating the exhaust pipe diverter.

Additionally, the control system 52, communicates with a remote control 57, for sending and receiving operational commands to the control system 52.

Additionally, located within housing 1, is electrical wiring from control system 52, to the clothes dryer 56 and electrical wiring from control system 52, to the airflow exhaust fan 46.

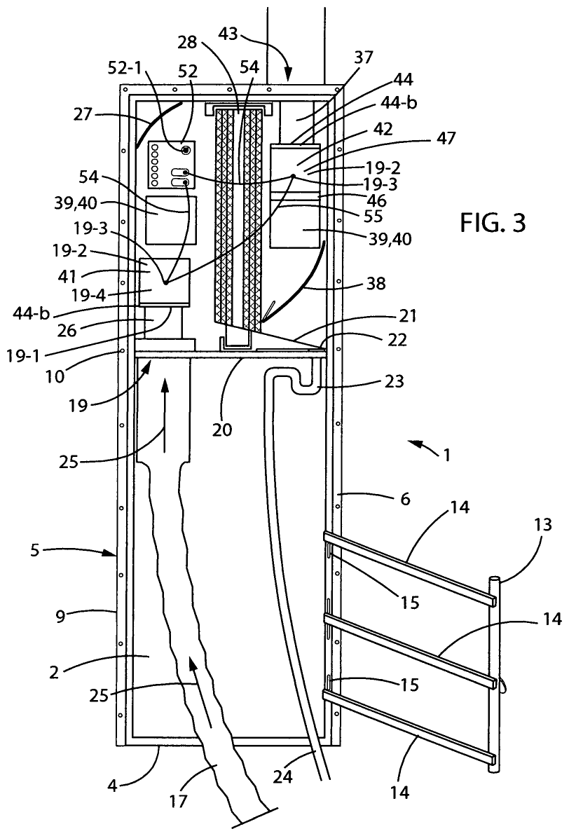

FIG. 3, illustrates a front view of the substantially open lower compartment 2, including a substantially closed upper compartment floor/substantially open lower compartment ceiling 20, which separates the substantially closed upper compartment 3, from the substantially open lower compartment 2.

Within the substantially open lower compartment 2, the moisture drain trap 23, prevents sewer gasses from entering the substantially closed upper compartment 3, and drains returning condensate moisture deriving from airflow exhaust pipe C, into the moisture disposal hose 24, which serves as a channel for water removal from the returning moisture drain 22.

Additionally, illustrated within the substantially open lower compartment 2, is the flexible airflow vent duct 17, which carries warm, moist airflow 25, from the clothes dryer CD, into the airflow receiving adapter 19.

Additionally, illustrated are the housing attachment flanges 9, attachment holes of housing flanges 10, which are means of supporting and attaching the housing 1; to a stud wall.

Additionally, illustrated is the hinged barrier in open position 13, hinged barrier adjustable cross bars 14, barrier hinges 15, which combines to provide an accessible and protected space within the substantially open lower compartment 2, to contain the flexible air flow vent duct 17, moisture disposal hose 24, and the moisture drain trap 23, when the hinged barrier is in closed position 12.

Additionally illustrated are the left side wall of housing 5, right side of housing 6, bottom wall of housing 4, which combined with the rear wall of housing 7, and top wall of housing 8, and front wall of substantially closed upper compartment 11, for providing the structure and containment of the housing 1.

Additionally, illustrated is airflow 25, passing thru the airflow receiving adapter 19, into the receiving airflow channel 26, and thru the clothes dryer airflow receiving port 19-1, and into the receiving airflow distribution device, 41.

Additionally, illustrated are the openable access openings 39, for observation and internal maintenance when in the open configuration, and the removable viewing windows 40, installed over the openable access openings 39.

Additionally, illustrated is the first airflow directional vane 27, located within the substantially closed upper compartment 3, for directing airflow 25, into the removable airflow filter assembly 28, and the second airflow directional vane 38 for directing airflow 25, exiting the removable airflow filter assembly 28, into the airflow exhaust fan 46.

Additionally, illustrated is the airflow exhaust fan 46, which moves airflow 25, thru the substantially closed upper compartment 3.

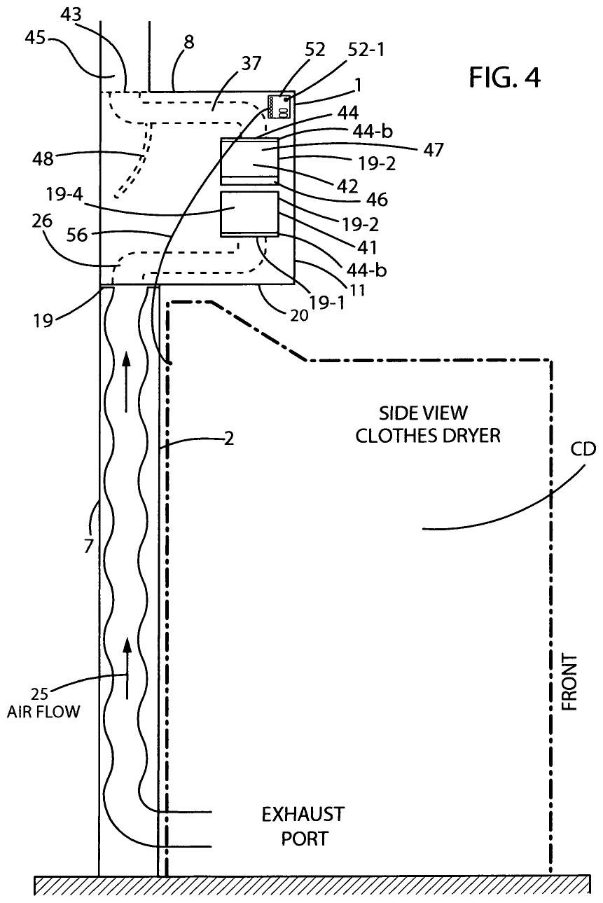

FIG. 4, illustrates a side view of housing 1, comprising the substantially open lower compartment 2, and substantially closed upper compartment 3, additionally, the housing 1, comprises the rear wall of housing 7, top wall of housing 8, front wall of substantially closed upper compartment 11, and substantially closed upper compartment floor/substantially open lower compartment ceiling 20, to provide a structural enclosure to be installed against an existing wall or sized to be installed within a typical wall cavity adjacent to the clothes dryer CD. Airflow 25, is derived from a clothes dryer CD, into the flexible airflow vent duct 17, and into the airflow receiving adapter 19, and into the receiving airflow channel 26 and into the receiving airflow distribution device 41.

Optionally, subject to positioning of the rotatable damper door 19-2, the airflow is derived from the building interior thru the building's interior airflow receiving port 19-4 into the receiving airflow distribution device 41.

The airflow 25, exits the receiving airflow distribution device 41, into and thru the removable airflow filter assembly 28, into the airflow exhaust fan 46, into the exiting airflow distribution device 42.

Additionally, the receiving airflow distribution device 41, contains a clothes dryer airflow receiving port 19-1, rotatable damper door 19-2, and interior room airflow receiving port 19-4. Additionally, the exiting airflow distribution device 42, contains a building's interior airflow exit port 47, building's exterior airflow exiting port 44, and a rotatable damper door 19-2.

Additionally, the housing 1, contains an exhaust airflow channel 37, airflow exhaust pipe connector 43, airflow exhaust pipe 45, to continue the airflow 25 thru the housing 1.

Additionally, illustrated is the moisture drain channel 48, which communicates with the exhaust airflow channel 37, for intercepting and draining away returning condensate moisture deriving from airflow exhaust pipe C.

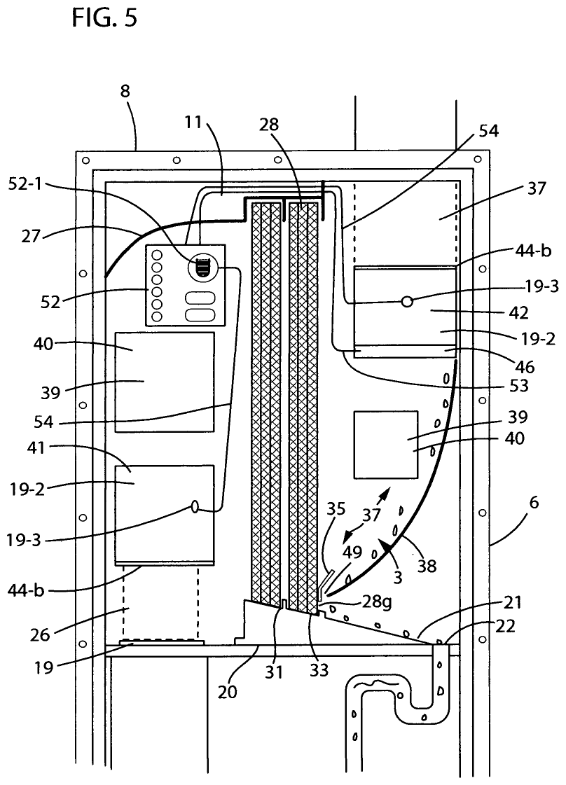

FIG. 5, illustrates a front view of the substantially closed upper compartment 3, with the front wall of substantially closed upper compartment 11, removed to expose the interior of the housing 1.

Illustrated is the removable airflow filter assembly 28, comprising a sloped frame bottom wall 33, serving as filter support, and a sloped lower guide 31, to assist as filter support and direct water toward the sloped basin shelf 21, which guides water into the returning moisture drain 22.

Additionally, illustrated is the airflow deflector 35 for directing airflow 25, upward and preventing airflow 25, from entering the returning moisture drain 22, and the moisture drip edge 49, to allow water to flow into the sloped basin shelf 21.

Additionally, illustrated are the moisture weep holes 28g, to allow drainage of any water that may collect within the removable airflow filter assembly 28.

Additional illustrations include rotatable damper door actuator 19-3, located on the rotatable damper doors 19-2 to manually or mechanically operate the rotatable damper doors 19-2. Additionally, the first airflow directional vane 27, and the second airflow directional vane 38, serve to smooth out wall corners of the housing 1, and direct airflow 25, thru the removable airflow filter assembly 28 and upward into the airflow exhaust fan 46, and into the exiting airflow distribution device 42.

Additionally, the openable access openings 39, which serves as openings thru the front wall of substantially closed upper compartment 11, for allowing servicing of the interior of housing 1. Additionally, the removable viewing windows 40, attach and seal the openable access openings 39, to allow viewing within when entry is not required.

Additionally illustrated is the electrical control system 52, comprising the monitor and alarm 52-1 communicating with both rotatable damper door actuators 19-3, thru the electrical wiring from said control system to receiving and exiting damper door actuators 54, and the electrical control system 52, communicating with the airflow exhaust fan 46, thru the electrical wiring from said control system to the airflow exhaust fan 53.

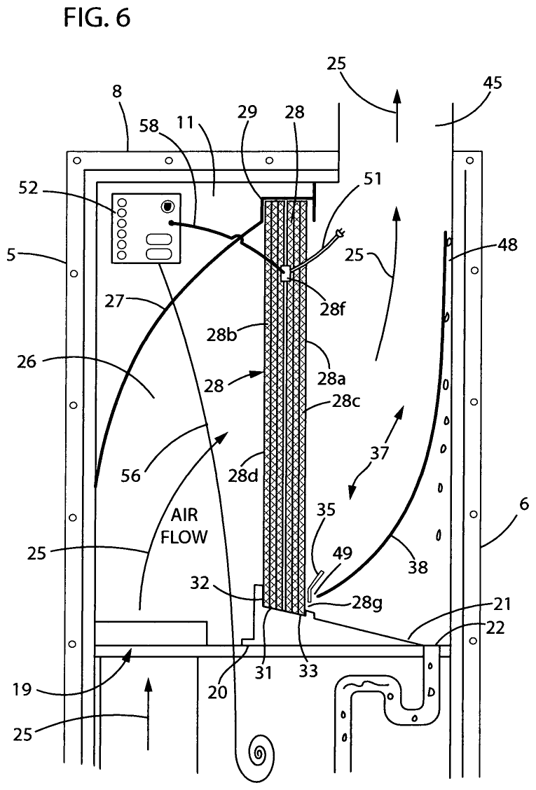

FIG. 6, illustrates a front view of substantially closed upper compartment 3, illustrating the airflow 25, entering thru the airflow receiving adapter 19, flowing upward and thru the removable airflow filter assembly 28, and continuing upward into the airflow exhaust pipe 45. Additionally, illustrated is the removable airflow filter assembly 28, designed to be removeable for cleaning and filter replacements, and designed to prevent returning constate moisture derived from airflow exhaust pipe C, from entering the airflow receiving adapter 19. Additionally, the removable airflow filter assembly 28, removes particulate and contamination from the airflow 25, as it passes thru the removable airflow filter assembly 28, thus producing clean, filtered airflow 25.

The removable airflow filter assembly 28, which comprises the airflow filter assembly frame 28a, which supports airflow sensers 28f, and airflow filter assembly hinges 28e, which are hinged to open for cleaning the first and second group of multiple airflow filter screens 28b& 28c, when removed from the substantially closed upper compartment 3.

The removable airflow filter assembly 28, is in closed position when inserted into the removable airflow filter assembly, frame upper guide 29, and sloped floor of lower guide 32 within the substantially closed upper compartment 3.

Additionally, the airflow filter assembly frame 28a, contains moisture weep holes 28g, for draining away any returning condensate moisture derived from airflow exhaust pipe C, which may enter into and flow from the removable airflow filter assembly 28.

The removable airflow filter assembly 28, further comprises the first group of multiple filter screens 28b, and the second group of multiple filter screens 28c that are located within the removable airflow filter assembly 28. The first group of multiple filter screens 28b, and the second group of multiple filter screens 28c, are attached to the multiple filter screen surrounds 28d, which is attached to the airflow filter assembly frame 28a.

The removable airflow filter assembly 28 receives airflow 25 from the receiving airflow distribution device 41.

The removable airflow filter assembly 28, further comprises multiple filter screen surrounds 28d, which consist of a structure for attaching and supporting the first group of multiple filter screens 28b, and the second group of multiple filter screens 28c.

The multiple filter screen surrounds 28d are connected to the airflow filter assembly frame 28a, with airflow filter assembly, hinges 28e, for folding together and for inserting into the substantially closed upper compartment 3 and unfolding when removed for cleaning.

The removable airflow filter assembly 28, further comprises the airflow filter assembly hinges 28e, which connects the multiple filter screen surrounds 28d, to the airflow filter assembly frame 28a and allows the first group of multiple filter screens 28b, and the second group of multiple filter screens 28c, to be unfolded open for cleaning and folded closed for inserting into the airflow filter assembly frame upper guide 29, and into the sloped floor of lower guide 32, of the substantially closed upper compartment 3, when in operational state.

The removable airflow filter assembly 28, further comprises the airflow sensers 28f, which are attached to the airflow filter assembly frame 28a, for quality control and airflow condition monitoring within the removable airflow filter assembly 28 and within the substantially closed upper compartment 3. The airflow censers 28f, communicates with the electrical control system 52, and monitor and alarm 52-1 for airflow diagnostics.

The removable airflow filter assembly 28, further comprises moisture weep holes 28g, which are located within the lower side of the airflow filter assembly frame 28a, for draining returning moisture derived from upward airflow exhaust pipe C, that may inadvertently flow back into the group of multiple filter screens 28b&28c, of the removable airflow filter assembly 28. The moisture weep holes 28g, provides drainage of the returning moisture derived from upward airflow exhaust pipe C, into the sloped basin shelf 21, for disposal through the returning moisture Drain 22.

The removable airflow filter assembly 28, further comprises an airflow filter assembly frame upper guide 29, which is located within the substantially closed upper compartment 3, for receiving and securing the airflow filter frame 28a, when it is inserted into its operational position inside the designated pocket within the substantially closed upper compartment 3. The airflow filter assembly frame upper guide 29, works jointly with the sloped floor lower guide 32, to secure the airflow filter assembly frame 28a, into its designated pocket. The removable airflow filter assembly 28, further comprises a frame of lower guide 30, located within the substantially closed compartment 3, for receiving and securing the airflow filter assembly frame 28a, when it is inserted into its operational position inside the substantially closed compartment 3.

The sloped floor of lower guide 32 works jointly with the airflow filter assembly, frame upper guide 29, to secure the airflow filter assembly frame 28a.

Additionally, the airflow filter assembly, frame 28a, has a sloped floor of lower guide 32, tapered downward toward the returning moisture drain 22, to produce a fit of the sloped frame bottom wall 33, which allows the airflow filter assembly frame 28a, to be “keyed” into the airflow filter assembly frame upper guide 29 and sloped floor of lower guide 32

The removable airflow filter assembly 28, further comprises a sloped lower guide 31, which is tapered toward the moisture drain 22, on the exit side of the filter frame 28a, to serve as a fit of the sloped floor of lower guide 32, which matches with the top of the sloped lower guide 31, to match with a sloped frame bottom wall 33, to insure proper placement of the airflow filter assembly frame 28a, within the airflow filter assembly frame upper guide 29 and sloped lower guides 31 and the frame of lower guide 30.

The removable airflow filter assembly 28, further comprises a sloped floor of lower guide 32, which is tapered to match the shape of the, sloped frame bottom wall 33, and matches the sloped lower guide 31, resulting in a matching fit and positioning of the airflow filter assembly frame 28a and insures proper insertion of the airflow filter assembly frame 28a, into the airflow filter assembly frame upper guide 29, and frame lower guide 30.

Additionally, the airflow deflector 35, directs airflow from the removable air flow filter assembly 28, upward toward the airflow exhaust pipe 45.

The removable airflow filter assembly 28, further comprises a sloped frame bottom wall 33, which matches the sloped floor of lower guide 32, to the sloped lower guide 31, which serves to provide a proper insertion and to secure placement of the airflow filter assembly frame 28a, into the airflow filter assembly frame upper guide 29, and frame of lower guide 30, within the substantially closed Compartment 3.

Additionally, illustrated is the second airflow directional vane 38, which serves to direct lateral airflow 25, exiting the removable airflow filter assembly 28, for sending the airflow 25, upward. Illustrated is the alternate moisture drain channel 48, which is separated from the alternate upper airflow channel 37, by the second airflow directional vane 38, to separate airflow 25, from returning condensate moisture deriving from airflow exhaust pipe C.

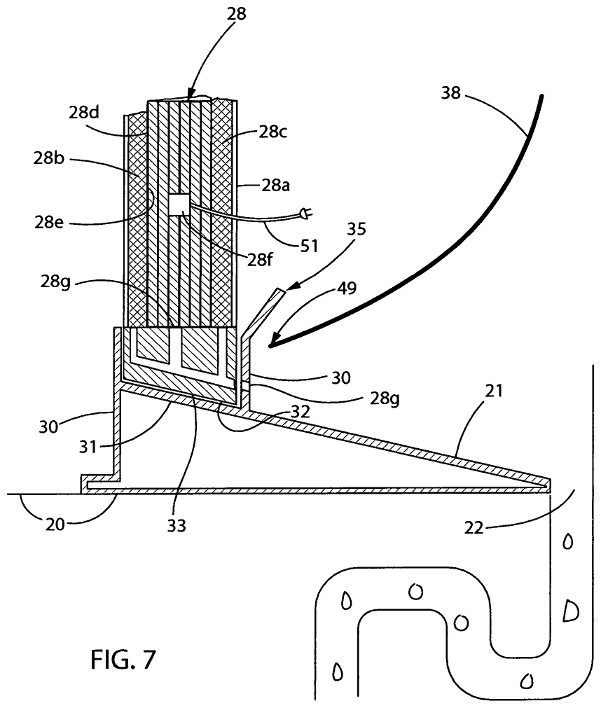

FIG. 7, illustrates an exploded view of removable airflow filter assembly 28, comprising the following:

The frame of lower guide 30, for receiving and securing the airflow filter assembly frame 28a. The sloped lower guide 31, tapered toward the returning moisture drain 22, on the exit side of the airflow filter assembly frame 28a, to serve as a fit of the sloped floor of lower guide 32. The sloped floor of lower guide 32, tapered to match the shape of the sloped frame bottom wall 33, and matches the sloped lower guide 31.

The sloped frame bottom wall 33, matches the sloped floor of lower guide 32, to the sloped lower guide 31, which serves to provide a proper insertion and to secure placement of the airflow filter assembly frame 28a.

Additionally, an electrical power supply 51, communicates with airflow sensors 28f, located within the removable airflow filter assembly 28, for providing electricity for filter screens requiring electricity

The airflow deflector 35, is an airflow directional guide with its lower end connected to the filter frame lower guide 30, with its body projected upward and away from the removable airflow filter assembly 28, at about 45-degree angle to direct airflow 25, upward into the exiting airflow distribution device 42.

The moisture weep holes 28g, are located within the lower side of the airflow filter assembly frame 28a, of the removable airflow filter assembly 28, for receiving returning condensate moisture derived from airflow exhaust pipe C, that may inadvertently flow back into the group of multiple filter screens 28b & 28c. The first group of multiple filter screens 28b, comprising any or all or a combination of the following filter designs;

fiberglass-mesh filters, electrostatically charged filters, True HEPA filters, activated carbon charcoal filters, extended media filters, electronic filters with electric power supply 51, ultraviolet filters, ion filters and custom designed filters and filter combinations.

The custom designed filters for the first group of multiple filter screens 28b, may be selected and combined from existing generic or non-generic filter designs, sized and constructed to comply with this invention's specifications.

The second group of multiple filter screens 28c, comprising any or all or a combination of the following filter designs;

fiberglass-mesh filters, electrostatically charged filters, TRUE-HEPA filters, activated carbon charcoal filters, extended media filters, electronic filters with electric power supply 51, ultraviolet filters, ion filters custom designed filters and filter combinations.

The custom designed filters for the second group of multiple tilter screens 28c, may be selected and combined from existing generic or non-generic filter designs, sized and constructed to comply with this invention's specifications.

The multiple filter screen surrounds 28d, consist of a structure for attaching and supporting the group of multiple filter screens 28b, & 28c, and are connected to the airflow filter assembly frame 28a.

The airflow filter assembly, hinges 28e, connects the multiple filter screen surrounds 28d, to the airflow filter assembly frame 28a and allows the first group of multiple filter screens 28b, and second group of multiple filter screens 28c, to be folded open for cleaning/replacement and folded to a closed position for inserting into the airflow filter assembly frame upper guide 29, and into the sloped floor of lower guide 32.

Additionally, illustrated is the moisture drip edge 49, located at the lower tip of the second airflow vane 38, allows returning condensate moisture derived from airflow exhaust pipe C, to drip downward into the sloped basin shelf 21, while preventing airflow 25, from entering the sloped basin shelf 21.

Additionally, illustrated is the second airflow directional vane 38, which turns the latterly flowing airflow 25, after flowing thru the removable airflow filter assembly 28, to an upward direction.

Additionally illustrated is the sloped basin shelf 21, which is positioned to receive moisture from the removable airflow filter assembly 28, and from the moisture drip edge 49, and deliver the Moisture to the returning moisture drain 22.

Additionally illustrated is the returning moisture drain 22, which receives moisture from sloped basin shelf 21, and delivers moisture into the returning moisture drain 22.

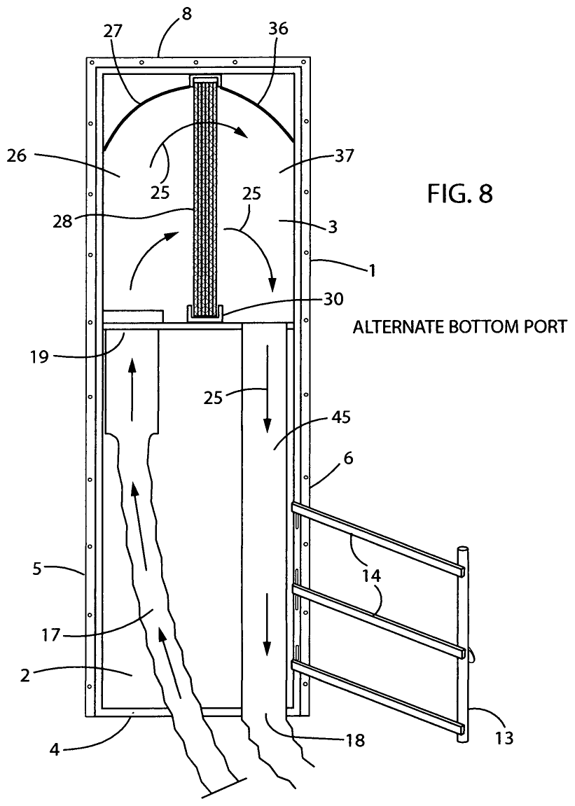

FIG. 8, illustrates a front view of an alternate bottom port within the housing 1, the airflow 25, travels thru the flexible airflow vent duct 17, into the alternate receiving airflow channel 26, directed by the first airflow directional vane 27, thru the removable airflow filter assembly 28, and directed by the alternate airflow directional vane 36, downward thru the alternate exhaust airflow channel 37, into the airflow exhaust pipe 45, exiting the substantially open lower compartment 2, and thru the alternate vent knockout 18.

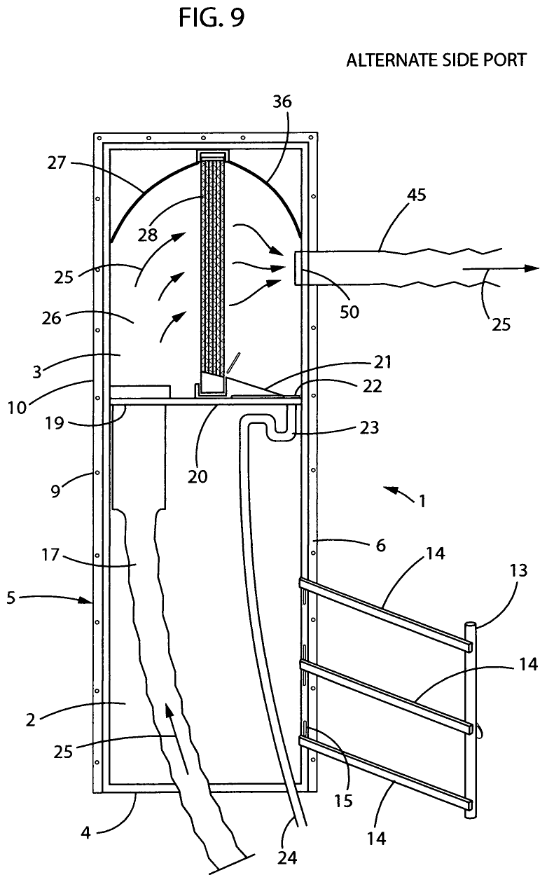

FIG. 9, illustrates a front view of an alternate airflow exit port 50, within the housing 1, the airflow 25, travels thru the flexible airflow vent duct 17, into the alternate receiving airflow channel 26, directed by the first airflow directional vane 27, thru the removable airflow filter assembly 28, and directed by the alternate airflow directional vane 36, thru the alternate airflow exit port 50, located on a side of housing 1, into the airflow exhaust pipe 45, to the exterior.

Additionally, illustrated are the housing attachment flanges 9, and attachment holes of housing flanges 10, for securing the housing 1, to a wall system. Additionally, illustrated is the hinged barrier in open position 13, comprising hinged barrier adjustable cross bars 14, and hinged barrier hinges 15.

The hinged barrier in open position 13, allows access into the substantially open lower compartment 2, for efficient placement of the flexible airflow vent duct 17.

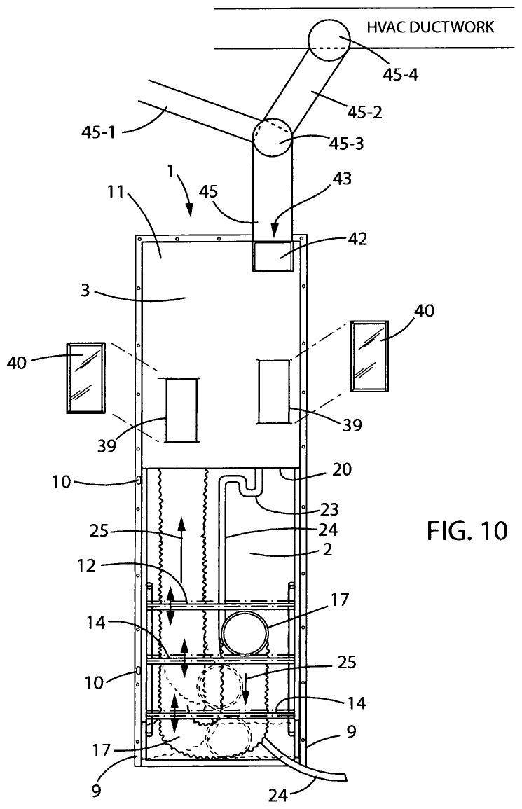

FIG. 10, illustrates a front view of the housing 1, with the substantially closed upper compartment 3, with the front wall of substantially closed upper compartment 11, installed.

The openable access openings 39, allow inspections, repairs and cleaning when not covered by the removable viewing windows 40, which when installed over the openable access openings 39, creates an airtight seal of the openable access openings 39.

Additionally illustrated is the substantially open lower compartment 2, with the flexible airflow vent duct 17, placed inside the substantially open lower compartment 2, secured by the hinged barrier in closed position 12.

Additionally illustrated is the moisture drain trap 23, connected to the moisture disposal hose 24, which extends outside of the substantially open lower compartment 2, to dispose returning condensate moisture derived from airflow exhaust pipe.

Additionally illustrated is an airflow exhaust system being substantially hollow comprising, an airflow exhaust pipe 45, extending from the housing 1, connected to the airflow exhaust pipe connector 43, on a first end and connecting on its second end to a first open receiving end of a hollow Wye Diverter 45-3, constructed with two additional outlet ends forked for providing two separate airflow exiting branches, and

said Wye Diverter 45-3, having a first open receiving end and two separate airflow exiting ends, and

a damper door within said Wye Diverter 45-3, for selecting one or another exiting ends constructed for airflow passage, and

the damper door within the Wye Diverter 45-3, constructed to block off one exit end resulting in the other exit end to be in an open position for airflow 25, and

a hollow extended airflow pipe to the exterior atmosphere 45-1, constructed as a channel for carrying airflow 25, from the Wye Diverter 45-3, thru the building's exterior wall to the exterior; and

a hollow extended airflow pipe to a HVAC Ductwork 45-2, constructed as a channel for carrying airflow 25, from the Wye Diverter 45-3, into a HVAC Ductwork system or into an alternate exclusive distribution system; and

an airflow damper 45-4, located within the junction of said extended airflow pipe and said HVAC Ductwork 45-2, constructed to regulate airflow within said HVAC Ductwork and within said extended airflow pipe 45-2, for preventing HVAC airflow from entering said extended airflow pipe 45-2, during non-operating periods of said airflow exhaust fan 46, located within the housing 1, and

the airflow damper 45-4, constructed for safe and efficient blending of airflow 25, and HVAC produced airflow to circulate airflow within the building's interior.

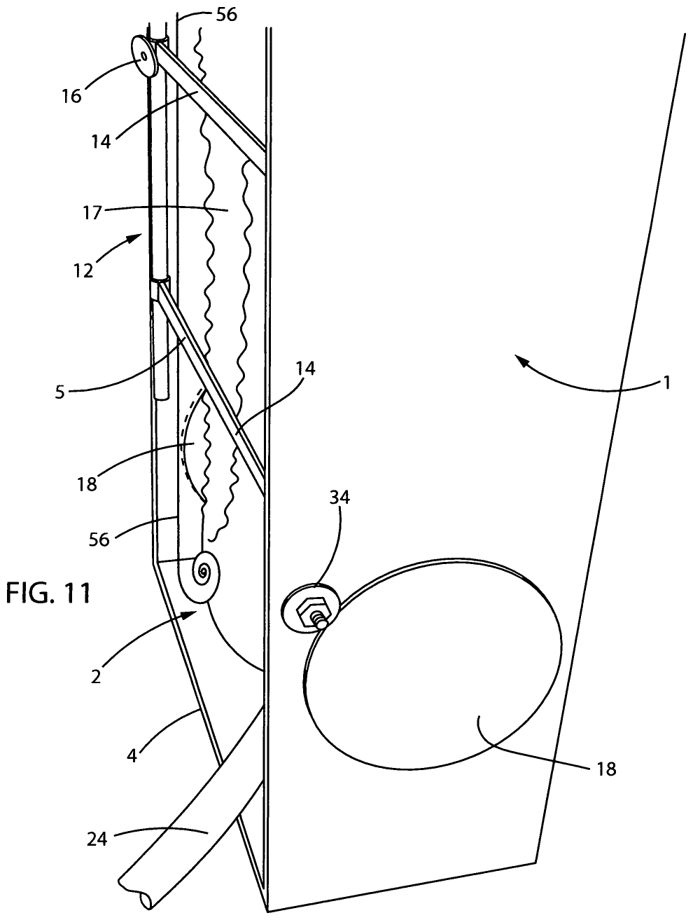

FIG. 11, illustrates a perspective view of the substantially open lower compartment 2, of the housing 1, with the flexible airflow vent duct 17, placed and secured by the hinged barrier in closed position 12, which is attached by the hinged barrier attachment 34.

Additionally, the hinged barrier in closed position 12, comprises the hinged barrier adjustable cross bars 14, and hinged barrier control mechanism 16, which moves the hinged barrier in closed position 12, and moves the hinged barrier in open position 13, to provide access to the substantially open lower compartment 2.

Additionally illustrated is the bottom wall of housing 4, vent knockouts, left, right, and bottom walls 18, and the moisture disposal hose 24.

Additionally, illustrated is the electrical wiring from control system to clothes dryer 56, coiled for future connection to the clothes dryer CD.

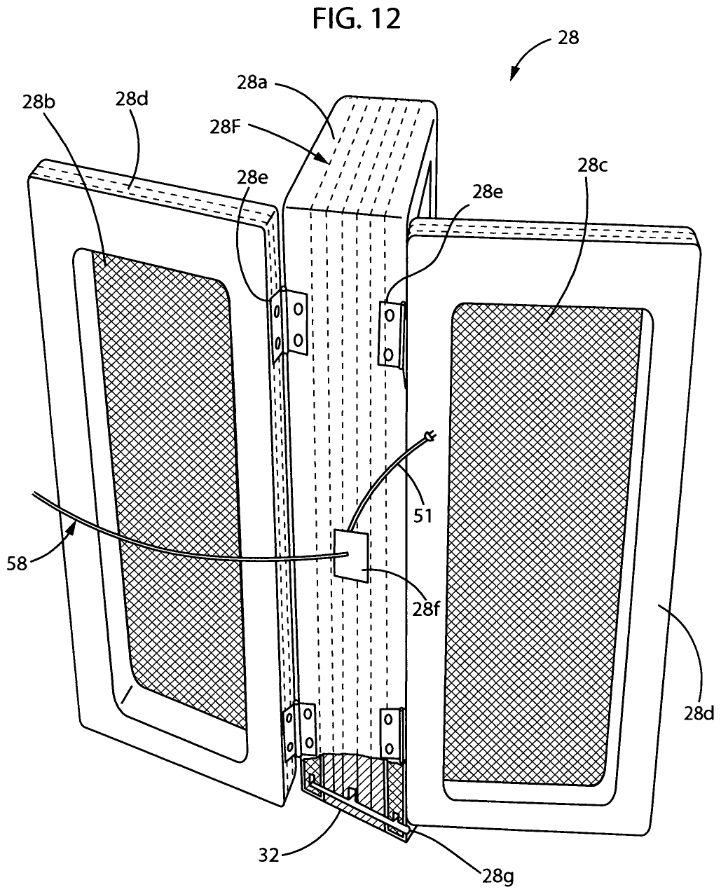

FIG. 12, illustrates an exploded view of removable airflow filter assembly 28, comprising of the following;

The moisture weep holes 28g, are located within the lower side of the airflow filter assembly frame 28a, of the removable airflow filter assembly 28, for receiving returning condensate moisture deriving from airflow exhaust pipe C, that may inadvertently flow back into the removable airflow filter assembly 28.

The first group of multiple filter screens 28b, comprising any or all or a combination of the following filter designs;

fiberglass-mesh filters, electrostatically charged filters, True HEPA filters, activated carbon charcoal filters, extended media filters, electronic filters with electric power supply 51, ultraviolet filters, ion filters and custom designed filters and filter combinations.

The custom designed filters for the first group of multiple filter screens 28b, may be selected and combined from existing generic or non-generic filter designs, sized and constructed to comply with this invention's specifications.

The second group of multiple filter screens 28c, comprising any or all or a combination of the following filter designs;

fiberglass-mesh filters, electrostatically charged filters, TRUE-HEPA filters, activated carbon charcoal filters, extended media filters, electronic filters with electric power supply 51, ultraviolet filters, ion filters and original custom designed filter combinations.

The custom designed filters for the second group of multiple filter screens 28c, may be selected and combined from existing filter designs or currently non-existing filter designs, custom designed filters are specified to comply with this invention's specifications.

The multiple filter screen surrounds 28d, consist of a structure for attaching and supporting the group of multiple filter screens 28b, & 28c, and are connected to the airflow filter assembly frame 28a.

The airflow filter assembly, hinges 28e, connects the multiple filter screen surrounds 28d, to the airflow filter assembly frame 28a and allows the first group of multiple filter screens 28b, and second group of multiple filter screens 28c, to be folded open for cleaning and replacement and folded to a closed position for inserting into the airflow filter assembly frame upper guide 29, and into the sloped floor of lower guide 32.

Additionally, airflow sensers 28f, which are attached to the airflow filter assembly frame 28a, for quality control and airflow condition monitoring within the removable airflow filter assembly 28 communicates with the control system 52, and monitor and alarm 52-1.

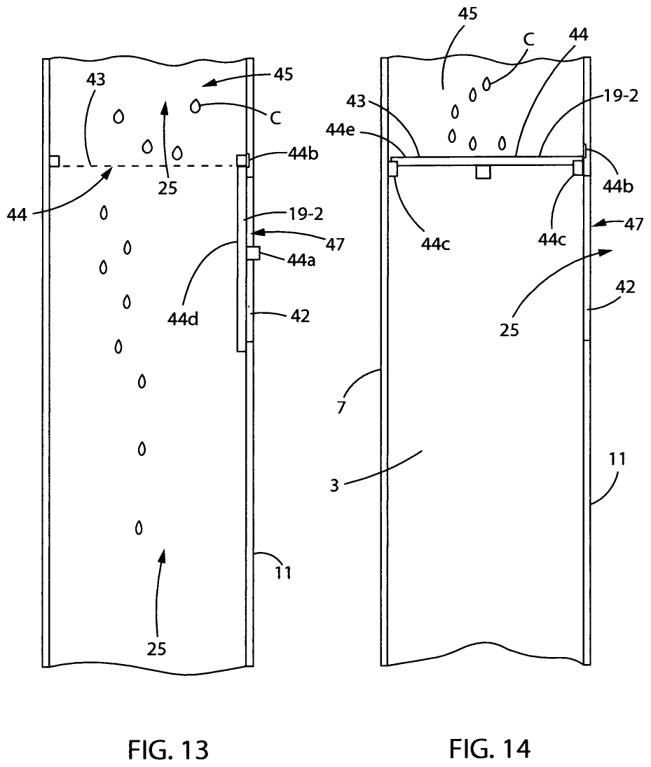

FIG. 13, illustrates a side view of airflow 25, exiting thru the building's exterior airflow exiting port 44, and thru the airflow exhaust pipe connector 43, into the airflow exhaust pipe 45, with returning condensate moisture derived from airflow exhaust pipe C, flowing downward.

The rotatable damper door 19-2, of the exiting airflow distribution device 42, is in the open position of rotatable damper door 44d, resulting in building's interior airflow exiting port 47, being closed.

The manual damper door control mechanism 44a, manually controls the rotatable damper door 19-2, and the damper door hinge 44b, is attached to the damper door 19-2 and to the front wall of substantially closed upper compartment 11.

Additionally, the manual damper door control mechanism 44a, operates the rotatable damper doors 19-2, within the receiving airflow distribution device 41, and within the exiting airflow distribution device 42.

Within the receiving airflow distribution device 41, airflow 25, can be received thru the clothes dryer airflow receiving port 19-1, or received thru the building's interior airflow receiving port 19-4, subject to positioning of the rotatable damper door 19-2, which is positioned either electrically or by the manual damper door control mechanism 44a.

Within the exiting airflow distribution device 42, airflow 25, can be expelled thru the building's interior airflow exiting port 47, or expelled thru the building's exterior airflow exiting port 44, subject to positioning of the rotatable damper door 19-2, which is positioned either manually or by the manual damper door control mechanism 44a.

FIG. 14, illustrates a side view of the substantially closed upper compartment 3, with the airflow 25, being blocked from entering the airflow exhaust pipe 45, and allowing airflow 25, to exit the buildings interior airflow exiting port 47, at the front of the exiting airflow distribution device 42.

The closed position of rotatable damper door 44e, of rotatable damper door 19-2, within the exiting airflow distribution device 42, prevents airflow 25, from entering the airflow exhaust pipe 45, and directs the airflow 25, to exit thru the building's interior airflow exiting port 47. Additionally, illustrated is the damper door hinge 44b connected to the front wall of substantially closed upper compartment 11, and connected to the rotatable damper door 19-2 for rotation between the building's interior airflow exiting port 47, and building's exterior airflow exiting port 44.

Additionally, damper door air seal 44c, blocks air and water leakage when the rotatable damper door 19-2 is in a closed position.

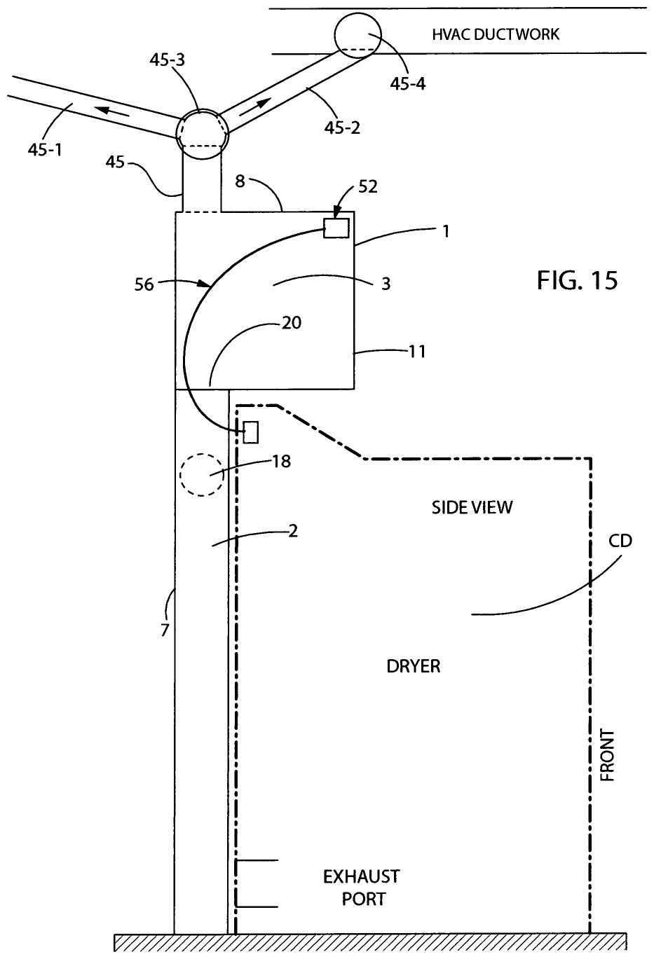

FIG. 15, illustrates a side view of housing 1, adjacent to the clothes dryer CD, Illustrating the substantially open lower compartment 2, with the vent knockouts, left, right and bottom walls 18, and the substantially closed upper compartment floor/substantially open lower compartment ceiling 20, which separates the substantially open lower compartment 2, from the substantially closed upper compartment 3, and additionally serves to make the substantially closed upper compartment 3, airtight.

The substantially closed upper compartment 3, comprises a front wall of substantially closed upper compartment 11, comprises a top wall of housing 8, comprises a rear wall of housing 7, and comprising airflow exhaust pipe 45,

additionally illustrated is the control system 52, communicating with the clothes dryer CD, thru the electrical wiring from control system to clothes dryer 56, for signaling emergency shutdown commands when warranted.

Additionally illustrated is an airflow exhaust system being substantially hollow comprising, an airflow exhaust pipe 45, extending from the housing 1, connected to the airflow exhaust pipe connector 43, on a first end and connecting on its second end to a first open receiving end of the hollow Wye Diverter 45-3, constructed with two additional outlet ends forked for providing two separate airflow exiting branches, and

said Wye Diverter 45-3, having a first open receiving end and two separate airflow exiting ends, and

a damper door within said Wye Diverter 45-3, for selecting one or another exiting ends constructed for airflow passage, and

the damper door within the Wye Diverter 45-3, constructed to block off one exit end resulting in the other exit end to be in an open position for airflow 25, and

a hollow extended airflow pipe to the exterior atmosphere 45-1, constructed as a channel for carrying airflow 25, from the Wye Diverter 45-3, thru the building's exterior wall to the exterior; and

a hollow extended airflow pipe to a HVAC Ductwork 45-2, constructed as a channel for carrying airflow 25, from the Wye Diverter 45-3, into a HVAC Ductwork system or into an alternate exclusive distribution system; and

an airflow damper 45-4, located within the junction of said extended airflow pipe and said HVAC Ductwork 45-2, constructed to regulate airflow within said HVAC Ductwork and within said extended airflow pipe 45-2, for preventing HVAC airflow from entering said extended airflow pipe 45-2, during non-operating periods of said airflow exhaust fan 46, located within the housing 1, and

the airflow damper 45-4, constructed for safe and efficient blending of airflow 25, and HVAC produced airflow to circulate airflow within the building's interior.

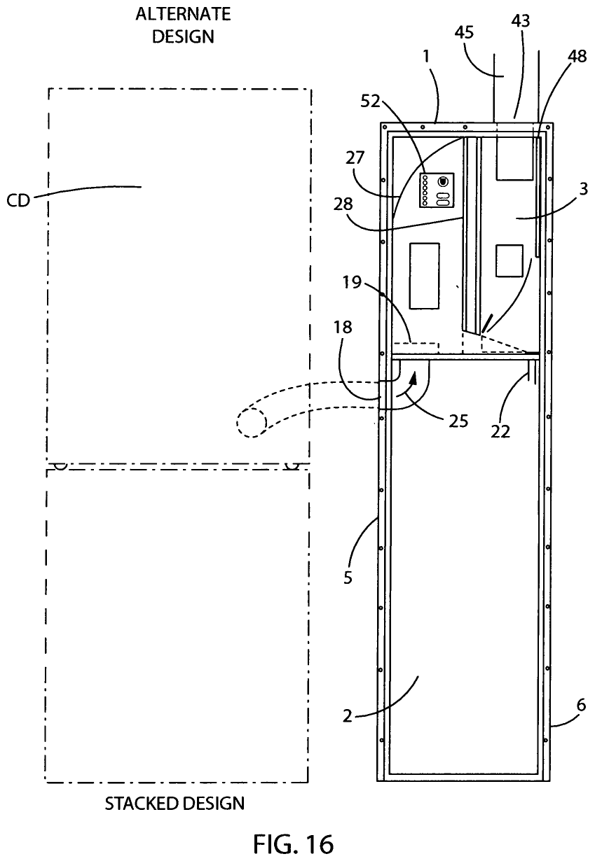

FIG. 16, illustrates a front view of an alternate design to serve a clothes dryer CD, stacked design with the airflow 25, derived from the clothes dryer CD, entering the substantially open lower compartment 2, thru the vent knockouts, left, right and bottom walls 18, and thru the airflow receiving adapter 19, into the substantially closed upper compartment 3.

Additionally illustrated are the removable airflow filter assembly 28, moisture drain channel 48, airflow exhaust pipe 45, first airflow directional vane 27, left wall of housing 5, right side of housing 6, returning moisture drain 22, control system 52.

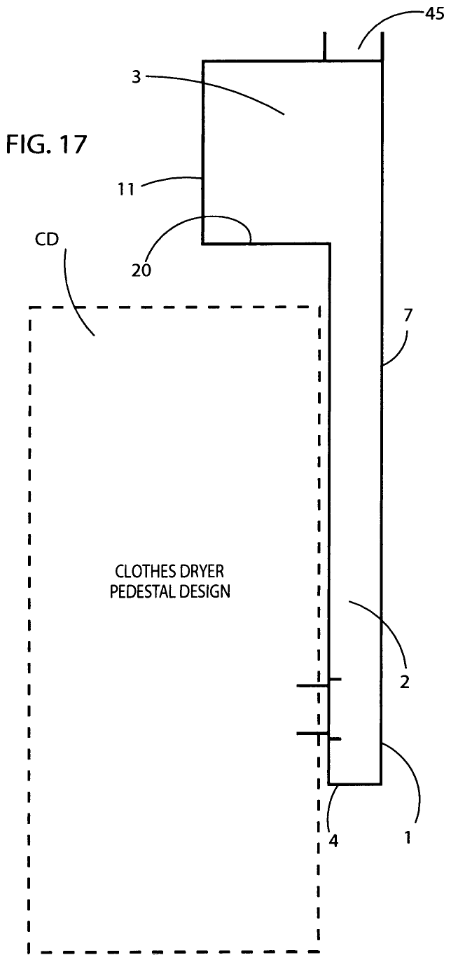

FIG. 17, illustrates a side view of housing 1, in an alternate raised from the floor installation of the housing 1, in order to accommodate a taller clothes dryer pedestal design.

Illustrated is the relationship of the housing 1 to the pedestal design of the clothes dryer CD. Additionally, illustrated is the rear wall of housing 7, the front wall of substantially closed upper compartment 11, the substantially closed upper compartment floor/substantially open lower compartment ceiling 20, and the airflow exhaust pipe 45.

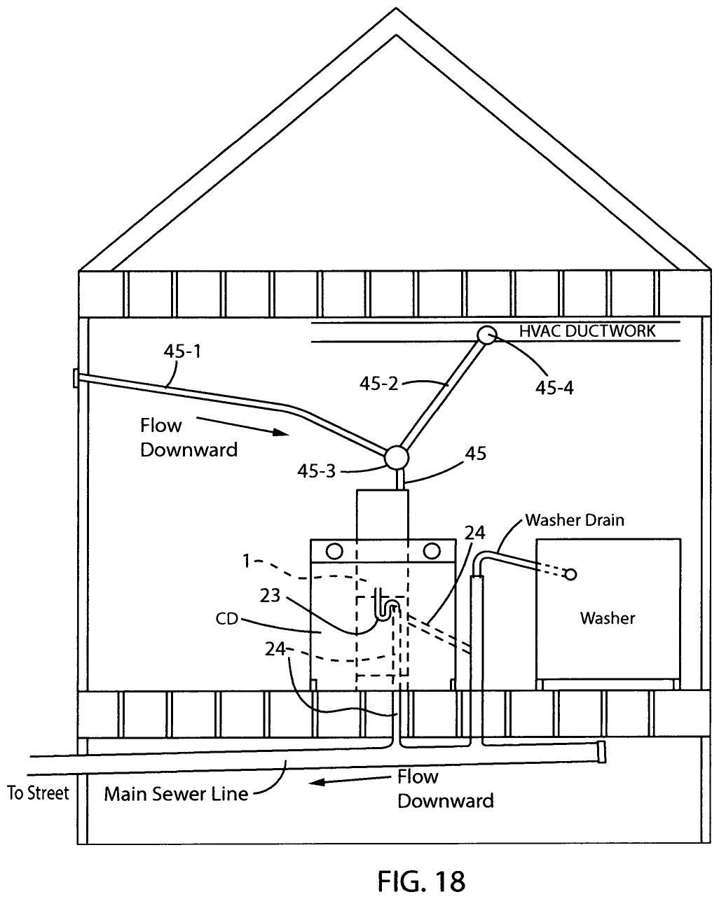

FIG. 18, illustrates a front view of a typical housing 1, configuration in relationship to a clothes washer and clothes dryer CD, additionally illustrated is the clothes washer drain.

The clothes washer drain accepts returning condensate moisture deriving from airflow exhaust pipe C, thru the moisture drain trap 23, and thru the moisture disposal hose 24.

Alternately, the moisture disposal hose 24, can be directly or indirectly connected to the Main Sewer Line for disposal.

Additionally illustrated is an airflow exhaust system being substantially hollow comprising, an airflow exhaust pipe 45, extending from the housing 1, connected to the airflow exhaust pipe connector 43, on a first end and connecting on its second end to a first open receiving end of a hollow Wye Diverter 45-3, constructed with two additional outlet ends forked for providing two separate airflow exiting branches, and

said Wye Diverter 45-3, having a first open receiving end and two separate airflow exiting ends, and

a damper door within said Wye Diverter 45-3, for selecting one or another exiting ends constructed for airflow passage, and

the damper door within the Wye Diverter 45-3, constructed to block off one exit end resulting in the other exit end to be in an open position for airflow 25, and

a hollow extended airflow pipe to the exterior atmosphere 45-1, constructed as a channel for carrying airflow 25, from the Wye Diverter 45-3, thru the building's exterior wall to the exterior; and

a hollow extended airflow pipe to a HVAC Ductwork 45-2, constructed as a channel for carrying airflow 25, from the Wye Diverter 45-3, into a HVAC Ductwork system or into an alternate exclusive distribution system; and

an airflow damper 45-4, located within the junction of said extended airflow pipe and said HVAC Ductwork 45-2, constructed to regulate airflow within said HVAC Ductwork and within said extended airflow pipe 45-2, for preventing HVAC airflow from entering said extended airflow pipe 45-2, during non-operating periods of said airflow exhaust fan 46, located within the housing 1, and

the airflow damper 45-4, constructed for safe and efficient blending of airflow 25, and HVAC produced airflow to circulate airflow within the building's interior.

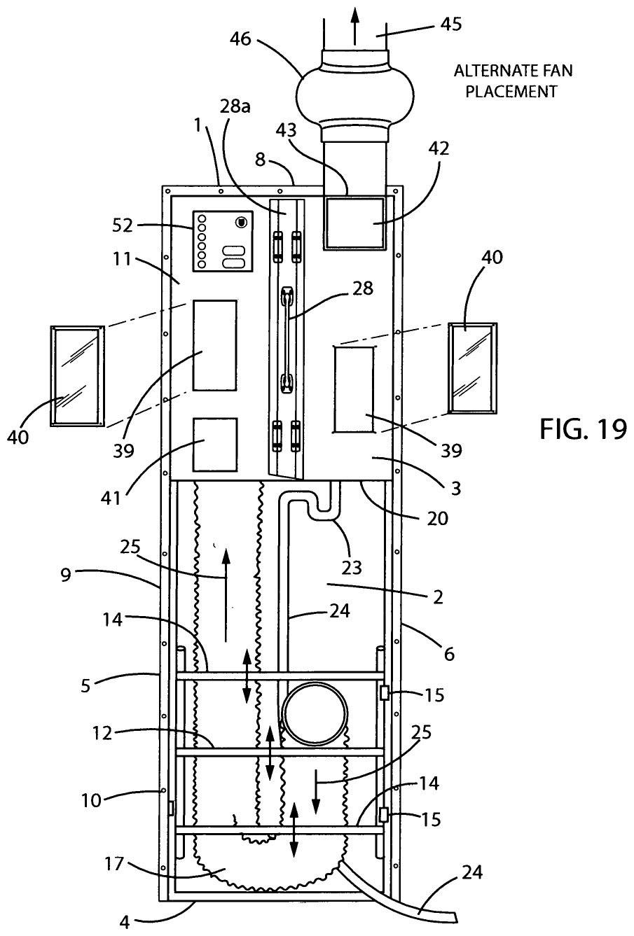

FIG. 19, illustrates a front view of housing 1, with an alternate fan placement of the airflow fan 46, located above and connected to the airflow exhaust pipe connector 43, and below and connected to the airflow exhaust pipe 45.

The alternate placement of airflow exhaust fan 46, located outside and above the housing 1, serves as an alternate fan location when a high volume/high velocity fan is required, such as in a commercial or industrial installation.

Additionally, illustrated is the front wall of substantially closed upper compartment 11, installed to cover the front wall of the substantially closed upper compartment 3.

Additionally, the front wall of substantially closed upper compartment 11, contains openings for the control system, 52, and removable airflow filter assembly 28, and receiving airflow distribution device 41, and exiting airflow distribution device 42, and openable access openings 39, and removable viewing windows 40.

Additionally, the control system 52, which is electrified to provide visual alerts and audible alerts of safety issues and airflow inefficiencies within the housing 1, including but not limited to airflow vent blockage, interior over-heating and filter blockage or a combination of each. Additionally, the control system 52. Is located within the substantially closed upper compartment 52.

Additionally, within the substantially open lower compartment 2, is the flexible airflow vent duct 17, moisture drain trap 23, and moisture disposal hose 24, efficiently positioned and secured by the hinged barrier in closed position 12.

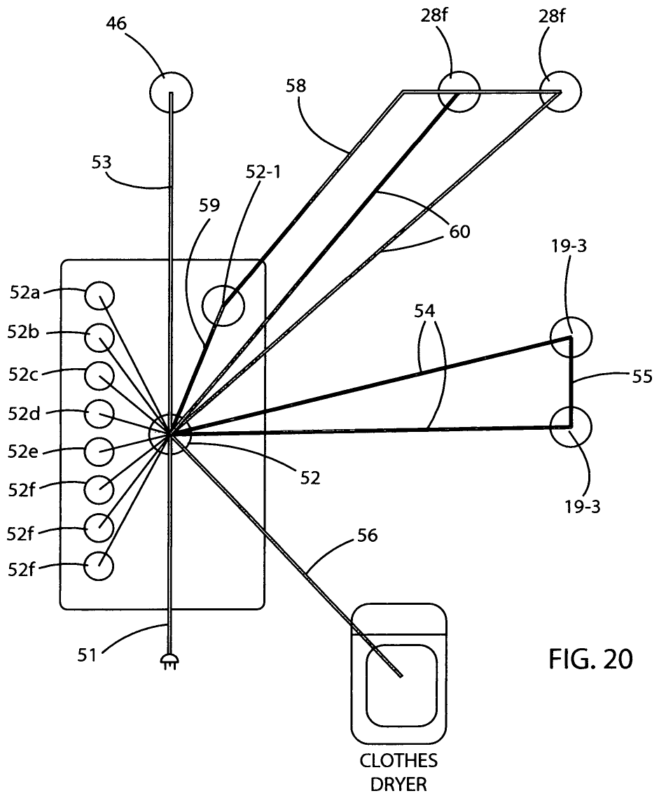

FIG. 20, illustrates the electrical control system 52;

comprising a monitor and alarm 52-1, for providing visual and recorded data and an alarm for audible notifications of emergency and abnormal conditions within the housing 1.

Additionally, a bank of switches, comprising a switch 52a, to activate ON/OFF electrical power supply to all components of the control system.

Additionally, a switch 52b, for activating airflow 25, to be received thru the clothes dryer airflow receiving port 19-1, and the same airflow 25, exiting thru the building's exterior airflow exiting port 44, to the exterior atmosphere.

Additionally, a switch 52c, for activating airflow 25, to be received thru the clothes dryer airflow receiving port 19-1, and the same airflow 25, exiting thru the building's interior airflow exiting port 47, into the building's interior as filtered airflow.

Additionally, a switch 52d, for activating airflow 25, to be received thru the building's interior airflow receiving port 19-4, and the same airflow 25, exiting thru the building's exterior airflow exiting port 44, to the exterior atmosphere.

Additionally, a switch 52e, for activating airflow 25 to be received thru the building's interior airflow receiving port 19-4, and the same airflow 25, exiting thru the building's interior airflow exiting port 47, to the building's interior as filtered airflow.

Additionally, blank switches for future addition 52f, for additional electrical circuit needs are provided in the electrical control system 52.

51 illustrates electrical power wired into the electrical control system 52, for powering electrical components within the housing 1.

53, illustrates electrical wiring for communicating from the control system 52, to the airflow exhaust fan 46.

54, illustrates electrical wiring for communicating from the electrical control system 52, to the receiving and exiting rotatable damper door actuators 19-3.

55, illustrates electrical wiring for communicating between the receiving rotatable damper door actuator 19-3, and the exiting rotatable damper door actuator 19-3.

56, illustrates electrical wiring for communicating between the control system 52, and the clothes dryer CD, for emergency shutdowns of the clothes dryer CD, when conditions warrant.

57. Illustrates the remote control for distant operation of the control system.

58, illustrates electrical wiring for communicating between the monitor and alarm 52-1, and the airflow sensors 28f.

59, illustrates electrical wiring for communicating between the control system 52, and the monitor and alarm 52-1.

60, illustrates electrical wiring for communicating between the control system 52, and the airflow sensers 28f.

The present invention can be constructed from a variety of materials, and for safety considerations is preferable constructed of materials which are substantially fire resistant and have non-flammable and non-melting properties. Suitable materials include metal, ceramic and plastics having the appropriate properties, although other materials are also acceptable. The present invention can be formed as an integral piece using conventional injection molding techniques known in the art, although the invention is not limited in that regard.

For example, the present invention can also be constructed from flat stock metal using sheet metal tools. The invention is capable of a number of specific forms without departing from the spirit or essential attributes thereof.

Accordingly, the following claims should be referenced to determine the scope of the invention, rather than the foregoing specification.

### OPERATION

FIG. 1, illustrates a perspective view of the housing 1, comprising a substantially closed upper compartment 3, a clothes dryer airflow receiving port 19-1, building's interior airflow receiving port 19-4, a receiving airflow channel 26, and a receiving airflow distribution device 41, with a damper door hinge 44-b.

Additionally, comprising openable access openings 39, with removable viewing windows 40, which provides a means to enter and examine the interior of the substantially closed upper compartment 3.

Airflow 25 is received into the receiving airflow distribution device 41, thru either the clothes dryer airflow receiving port 19-1, or thru the building's interior airflow receiving port 19-4, subject to the position of the rotatable damper door 19-2, which is controlled by the rotatable damper door actuator 19-3.

Additionally, included is a control system 52, which provides real-time operations and diagnostics of the system within the housing 1.

Additionally, the electrical control system 52, communicates with the remote control 57, for sending and receiving operational commands to the control system 52.

Additionally, included is the removable airflow filter assembly 28, which comprises a multi-filter airflow purification system.

Additionally, an airflow exhaust fan 46, with electric power supply 51, is located within the housing 1, for moving airflow 25, in thru the clothes dryer airflow receiving port 19-1, or in thru the building's interior airflow receiving port 19-4, and thru the receiving airflow distribution device 41, and thru the removable airflow filter assembly 28, and into the exiting airflow distribution device 42 and out thru the building's exterior airflow exiting port 44, or out thru the building's interior airflow exiting port 47.

Additionally, the airflow exhaust fan 46, constructed as a module unit for placement within a designated pocket and constructed for efficient removal and replacement and noninvasive transition within said housing 1.

The exiting airflow distribution device 42, has two exit ports, first is the building's exterior airflow exiting port 44, which directs airflow 25, into the exhaust airflow channel 37,

and the other second exit port, is the building's interior airflow exiting port 47.

The selection between the building's exterior airflow exiting port 44, or the building interior airflow exiting port 47, for airflow 25, direction is dependent on the positioning of the rotatable damper door 19-2. The rotatable damper door 19-2 positioning is controlled by the rotatable damper door actuator 19-3.

When the Airflow 25, is directed thru the building's exterior airflow exiting port 44, by the positioning of the rotatable damper door 19-2, the airflow 25, enters the exhaust airflow channel 37, and continues thru the airflow exhaust pipe connector 43, into the airflow exhaust pipe 45, for removal into the outside atmosphere.

The building's exterior airflow exiting port 44, located within the exiting airflow distribution device 42, communicates with the exhaust airflow channel 37, which communicates with the airflow exhaust pipe connector 43, which communicates with the airflow exhaust pipe 45.

The moisture drain channel 48, communicates with the exhaust airflow channel 37, for accepting returning condensate moisture deriving from airflow exhaust pipe C, thus preventing the returning condensate moisture derived from airflow exhaust pipe C, from entering the receiving airflow distribution device 41.

FIG. 2, illustrates a front view of the substantially closed upper compartment 3, of the housing 1. The airflow 25, is drawn thru the airflow receiving adapter 19, into the lower airflow channel 26, and into the receiving airflow distribution device 41.

The receiving airflow distribution device 41, contains two airflow receiving ports, first, the clothes dryer airflow receiving port 19-1, and second, the building's interior airflow receiving port 19-4. Additionally, the receiving airflow distribution device 41, contains a rotatable damper door 19-2, which is manually or mechanically controlled to rotate by the rotatable damper door actuator 19-3, for rotating to close either the clothes dryer airflow receiving port 19-1 or for closing the building's interior airflow receiving port 19-4, resulting in the non-closed receiving port being open to receive airflow 25.

The airflow 25, being drawn thru the receiving airflow distribution device 41, by the airflow exhaust fan 46, passes thru the removable airflow filter assembly 28, and is drawn thru the airflow fan 46, into the exiting airflow distribution device 42, which contains two airflow exit ports, first, the building's exterior airflow exiting port 44, and second, the building's interior airflow exiting port 47.

Additionally, the exiting airflow distribution device 42, contains the rotatable damper door 19-2, which manually or mechanically rotates to close either the building's exterior airflow exiting port 44, or close the building's interior airflow exiting port 47, resulting in the non-closed exit port being open for exiting the airflow 25, out of the exiting airflow distribution device 42.

The airflow 25, exiting from the exiting airflow distribution device 42, thru the building's exterior airflow exiting port 44, continues into the exhaust airflow channel 37, and continues thru the airflow exhaust pipe connector 43, into the airflow exhaust pipe 45. and into the exterior atmosphere.

The airflow 25, exhausted from the exiting airflow distribution device 42, thru the building's interior airflow exiting port 47, is exited into the building interior atmosphere as filtered recirculated airflow.

Additionally, illustrated is the airflow deflector 35, which is the airflow 25, directional guide with its lower end connected to the frame of lower guide 30, with its body extending upward and away from the removable airflow filter assembly 28, for directing airflow 25 upward into the airflow exhaust fan 46, and into the exiting airflow distribution device 42.

Additionally, illustrated is the control system 52, which comprises; 52-1, 52a, 52b, 52c, 52d, 52e, 52f, 53, 54, 55, 56, 57, 58, 59, and 60.

52-1. Monitor and alarm.

52a. An On/Off control switch for activating and deactivating the airflow exhaust fan 46.

52b. A switch for activating the rotatable damper door actuator 19-3 of the receiving airflow distribution device 41, to allow airflow 25, in thru clothes dryer airflow receiving port 19-1, and for activating the rotatable damper door actuator 19-3, of the exiting airflow distribution device 42, to allow same airflow 25, out thru the building's exterior airflow exiting port 44.

52c. A switch for activating the rotatable damper door actuator 19-3, of the receiving airflow distribution device 41, to allow airflow 25, in thru clothes dryer airflow receiving port 19-1, and for activating the rotatable damper door actuator 19-3, of the exiting airflow distribution device 42, to allow same airflow 25, out thru building's interior airflow exiting port 47.

52d. A switch for activating the rotatable damper door actuator 19-3, of the receiving airflow distribution device 41, to allow airflow 25, in thru building's interior airflow receiving port 19-4, and for activating the rotatable damper door actuator 19-3, of the exiting airflow distribution device 42, to allow same airflow 25, out thru the building's exterior airflow exiting port 44.

52e. A switch for activating the rotatable damper door actuator 19-3 of the receiving airflow distribution device 41, to allow airflow 25 in thru the building's interior airflow receiving port 19-4, and for activating the rotatable damper door actuator 19-3, to allow same airflow 25, out thru the building's interior airflow exiting port 47, for interior recycling.

52f. Blank switch for future addition.

Additionally, the control system 52, communicates with a remote control 57, for sending and receiving operational commands to the control system 52.

Additionally, located within housing 1, is electrical wiring from control system 52, to the clothes dryer 56 and electrical wiring from control system 52, to the airflow exhaust fan 46.

FIG. 3, illustrates a front view of the substantially open lower compartment 2, including a substantially closed upper compartment floor/substantially open lower compartment ceiling 20, which separates the substantially closed upper compartment 3, from the substantially open lower compartment 2.

Within the substantially open lower compartment 2, the moisture drain trap 23, prevents sewer gasses from entering the substantially closed upper compartment 3, and drains returning condensate moisture deriving from airflow exhaust pipe C, into the moisture disposal hose 24, which serves as a channel for water removal from the returning moisture drain 22.

Additionally, illustrated within the substantially open lower compartment 2, is the flexible airflow vent duct 17, which carries warm, moist airflow 25, from the clothes dryer CD, into the airflow receiving adapter 19.

Additionally, illustrated are the housing attachment flanges 9, attachment holes of housing flanges 10, which are means of supporting and attaching the housing 1, to a stud wall.

Additionally, illustrated is the hinged barrier in open position 13, hinged barrier adjustable cross bars 14, barrier hinges 15, which combines to provide an accessible and protected space within the substantially open lower compartment 2, to contain the flexible air flow vent duct 17, moisture disposal hose 24, and the moisture drain trap 23, when the hinged barrier is in closed position 12.

Additionally illustrated are the left side wall of housing 5, right side of housing 6, bottom wall of housing 4, which combined with the rear wall of housing 7, and top wall of housing 8, and front wall of substantially closed upper compartment 11, for providing the structure and containment of the housing 1.

Additionally, illustrated is airflow 25, passing thru the airflow receiving adapter 19, into the receiving airflow channel 26, and thru the clothes dryer airflow receiving port 19-1, and into the receiving airflow distribution device, 41.

Additionally, illustrated are the openable access openings 39, for observation and internal maintenance when in the open configuration, and the removable viewing windows 40, installed over the openable access openings 39.

Additionally, illustrated is the first airflow directional vane 27, located within the substantially closed upper compartment 3, for directing airflow 25, into the removable airflow filter assembly 28, and the second airflow directional vane 38 for directing airflow 25, exiting the removable airflow filter assembly 28, into the airflow exhaust fan 46.

Additionally, illustrated is the airflow exhaust fan 46, which moves airflow 25, thru the substantially closed upper compartment 3.

FIG. 4, illustrates a side view of housing 1, comprising the substantially open lower compartment 2, and substantially closed upper compartment 3, additionally, the housing 1, comprises the rear wall of housing 7, top wall of housing 8, front wall of substantially closed upper compartment 11, and substantially closed upper compartment floor/substantially open lower compartment ceiling 20, to provide a structural enclosure to be installed against an existing wall or sized to be installed within a typical wall cavity adjacent to the clothes dryer CD.

Airflow 25, is derived from a clothes dryer CD, into the flexible airflow vent duct 17, and into the airflow receiving adapter 19, and into the receiving airflow channel 26 and into the receiving airflow distribution device 41.

Optionally, subject to placement of the rotatable damper door 19-2, the airflow is derived from the building interior thru the building's interior airflow receiving port 19-4 into the receiving airflow distribution device 41.

The airflow 25, exits the receiving airflow distribution device 41, into and thru the removable airflow filter assembly 28, into the airflow exhaust fan 46, into the exiting airflow distribution device 42.

Additionally, the receiving airflow distribution device 41, contains a clothes dryer airflow receiving port 19-1, rotatable damper door 19-2, and interior room airflow receiving port 19-4.

Additionally, the exiting airflow distribution device 42, contains a building's interior airflow exit port 47, building's exterior airflow exiting port 44, and a rotatable damper door 19-2.

Additionally, the housing 1, contains an exhaust airflow channel 37, airflow exhaust pipe connector 43, airflow exhaust pipe 45, to continue the airflow 25 thru the housing 1.

Additionally, illustrated is the moisture drain channel 48, which communicates with the exhaust airflow channel 37, for intercepting and draining away returning condensate moisture deriving from airflow exhaust pipe C.

FIG. 5, illustrates a front view of the substantially closed upper compartment 3, with the front wall of substantially closed upper compartment 11, removed to expose the interior of the housing 1. Illustrated is the removable airflow filter assembly 28, comprising a sloped frame bottom wall 33, serving as filter support, and a sloped lower guide 31, to assist as filter support and direct water toward the sloped basin shelf 21, which guides water into the returning moisture drain 22.

Additionally, illustrated is the airflow deflector 35 for directing airflow 25, upward and preventing airflow 25, from entering the returning moisture drain 22, and the moisture drip edge 49, to allow water to flow into the sloped basin shelf 21.

Additionally, illustrated are the moisture weep holes 28g, to allow drainage of any water that may collect within the removable airflow filter assembly 28.

Additional illustrations include rotatable damper door actuator 19-3, located on the rotatable damper doors 19-2 to manually or mechanically operate the rotatable damper doors 19-2. Additionally, the first airflow directional vane 27, and the second airflow directional vane 38, serve to smooth out wall corners of the housing 1, and direct airflow 25, thru the removable airflow filter assembly 28 and upward into the airflow exhaust fan 46, and into the exiting airflow distribution device 42.

Additionally, the openable access openings 39, which serves as openings thru the front wall of substantially closed upper compartment 11, for allowing servicing of the interior of housing 1. Additionally, the removable viewing windows 40, attach and seal the openable access openings 39, to allow viewing within when entry is not required.

Additionally illustrated is the electrical control system 52, comprising the monitor and alarm 52-1 communicating with both rotatable damper door actuators 19-3, thru the electrical wiring from said control system to receiving and exiting damper door actuators 54,

and the electrical control system 52, communicating with the airflow exhaust fan 46, thru the electrical wiring from said control system to the airflow exhaust fan 53.

FIG. 6, illustrates a front view of substantially closed upper compartment 3, illustrating the airflow 25, entering thru the airflow receiving adapter 19, flowing upward and thru the removable airflow filter assembly 28, and continuing upward into the airflow exhaust pipe 45.

Additionally, illustrated is the removable airflow filter assembly 28, designed to be removeable for cleaning and filter replacements, and designed to prevent returning constate moisture derived from airflow exhaust pipe C, from entering the airflow receiving adapter 19.

Additionally, the removable airflow filter assembly 28, removes particulate and contamination from the airflow 25, as it passes thru the removable airflow filter assembly 28, thus producing clean, filtered airflow 25.

The removable airflow filter assembly 28, which comprises the airflow filter assembly frame 28a, which supports airflow sensers 28f, and airflow filter assembly hinges 28e, which are hinged to open for cleaning the first and second group of multiple airflow filter screens 28b& 28c, when removed from the substantially closed upper compartment 3.

The removable airflow filter assembly 28, is in closed position when inserted into the removable airflow filter assembly, frame upper guide 29, and sloped floor of lower guide 32 within the substantially closed upper compartment 3.

Additionally, the airflow filter assembly frame 28a, contains moisture weep holes 28g, for draining away any returning condensate moisture derived from airflow exhaust pipe C, which may enter into and flow from the removable airflow filter assembly 28.

The removable airflow filter assembly 28, further comprises the first group of multiple filter screens 28b, and the second group of multiple filter screens 28c that are located within the removable airflow filter assembly 28. The first group of multiple filter screens 28b, and the second group of multiple filter screens 28c, are attached to the multiple filter screen surrounds 28d, which is attached to the airflow filter assembly frame 28a.

The removable airflow filter assembly 28 receives airflow 25 from the receiving airflow distribution device 41.

The removable airflow filter assembly 28, further comprises multiple filter screen surrounds 28d, which consist of a structure for attaching and supporting the first group of multiple filter screens 28b, and the second group of multiple filter screens 28c.

The multiple filter screen surrounds 28d are connected to the airflow filter assembly frame 28a, with airflow filter assembly, hinges 28e, for folding together and for inserting into the substantially closed upper compartment 3 and unfolding when removed for cleaning.

The removable airflow filter assembly 28, further comprises the airflow filter assembly hinges 28e, which connects the multiple filter screen surrounds 28d, to the airflow filter assembly frame 28a and allows the first group of multiple filter screens 28b, and the second group of multiple filter screens 28c, to be unfolded open for cleaning and folded closed for inserting into the airflow filter assembly frame upper guide 29, and into the sloped floor of lower guide 32, of the substantially closed upper compartment 3, when in operational state.

The removable airflow filter assembly 28, further comprises the airflow sensers 28f, which are attached to the airflow filter assembly frame 28a, for quality control and airflow condition monitoring within the removable airflow filter assembly 28 and within the substantially closed upper compartment 3. The airflow sensers 28f, communicates with the electrical control system 52, and monitor and alarm 52-1 for airflow diagnostics.

The removable airflow filter assembly 28, further comprises moisture weep holes 28g, which are located within the lower side of the airflow filter assembly frame 28a, for draining returning moisture derived from upward airflow exhaust pipe C, that may inadvertently flow back into the group of multiple filter screens 28b&28c, of the removable airflow filter assembly 28.

The moisture weep holes 28g, provides drainage of the returning moisture derived from upward airflow exhaust pipe C, into the sloped basin shelf 21, for disposal through the returning moisture Drain 22.

The removable airflow filter assembly 28, further comprises an airflow filter assembly frame upper guide 29, which is located within the substantially closed upper compartment 3, for receiving and securing the airflow filter frame 28a, when it is inserted into its operational position inside the designated pocket within the substantially closed upper compartment 3.

The airflow filter assembly frame upper guide 29, works jointly with the sloped floor lower guide 32, to secure the airflow filter assembly frame 28a, into its designated pocket.

The removable airflow filter assembly 28, further comprises a frame of lower guide 30, located within the substantially closed compartment 3, for receiving and securing the airflow filter assembly frame 28a, when it is inserted into its operational position inside the substantially closed compartment 3.

The sloped floor of lower guide 32 works jointly with the airflow filter assembly, frame upper guide 29, to secure the airflow filter assembly frame 28a.

Additionally, the airflow filter assembly, frame 28a, has a sloped floor of lower guide 32, tapered downward toward the returning moisture drain 22, to produce a fit of the sloped frame bottom wall 33, which allows the airflow filter assembly frame 28a, to be “keyed” into the airflow filter assembly frame upper guide 29 and sloped floor of lower guide 32

The removable airflow filter assembly 28, further comprises a sloped lower guide 31, which is tapered toward the moisture drain 22, on the exit side of the filter frame 28a, to serve as a fit of the sloped floor of lower guide 32, which matches with the top of the sloped lower guide 31, to match with a sloped frame bottom wall 33, to insure proper placement of the airflow filter assembly frame 28a, within the airflow filter assembly frame upper guide 29 and sloped lower guides 31 and the frame of lower guide 30.

The removable airflow filter assembly 28, further comprises a sloped floor of lower guide 32, which is tapered to match the shape of the, sloped frame bottom wall 33, and matches the sloped lower guide 31, resulting in a matching fit and positioning of the airflow filter assembly frame 28a and insures proper insertion of the airflow filter assembly frame 28a, into the airflow filter assembly frame upper guide 29, and frame lower guide 30.

Additionally, the airflow deflector 35, directs airflow from the removable air flow filter assembly 28, upward toward the airflow exhaust pipe 45.

The removable airflow filter assembly 28, further comprises a sloped frame bottom wall 33, which matches the sloped floor of lower guide 32, to the sloped lower guide 31, which serves to provide a proper insertion and to secure placement of the airflow filter assembly frame 28a, into the airflow filter assembly frame upper guide 29, and frame of lower guide 30, within the substantially closed Compartment 3.

Additionally, illustrated is the second airflow directional vane 38, which serves to direct lateral airflow 25, exiting the removable airflow filter assembly 28, for sending the airflow 25, upward. Illustrated is the alternate moisture drain channel 48, which is separated from the alternate upper airflow channel 37, by the second airflow directional vane 38, to separate airflow 25, from returning condensate moisture deriving from airflow exhaust pipe C.

FIG. 7. illustrates an exploded view of removable airflow filter assembly 28, comprising the following;

The frame of lower guide 30, for receiving and securing the airflow filter assembly frame 28a.

The sloped lower guide 31, tapered toward the returning moisture drain 22, on the exit side of the airflow filter assembly frame 28a, to serve as a fit of the sloped floor of lower guide 32.

The sloped floor of lower guide 32, tapered to match the shape of the sloped frame bottom wall 33, and matches the sloped lower guide 31.

The sloped frame bottom wall 33, matches the sloped floor of lower guide 32, to the sloped lower guide 31, which serves to provide a proper insertion and to secure placement of the airflow filter assembly frame 28a.

Additionally, an electrical power supply 51, communicates with airflow sensors 28f, located within the removable airflow filter assembly 28, for providing electricity for filter screens requiring electricity

The airflow deflector 35, is an airflow directional guide with its lower end connected to the filter frame lower guide 30, with its body projected upward and away from the removable airflow filter assembly 28, at about 45-degree angle to direct airflow 25, upward into the exiting airflow distribution device 42.

The moisture weep holes 28g, are located within the lower side of the airflow filter assembly frame 28a, of the removable airflow filter assembly 28, for receiving returning condensate moisture derived from airflow exhaust pipe C, that may inadvertently flow back into the group of multiple filter screens 28b & 28c. The first group of multiple filter screens 28b, comprising any or all or a combination of the following filter designs;

fiberglass-mesh filters, electrostatically charged filters, TRUE HEPA filters, activated carbon charcoal filters, extended media filters, electronic filters with electric power supply 51, ultraviolet filters, ion filters and custom designed filters and filter combinations.

The custom designed filters for the first group of multiple filter screens 28b, may be selected and combined from existing generic or non-generic filter designs, sized and constructed to comply with this invention's specifications.

The second group of multiple filter screens 28c, comprising any or all or a combination of the following filter designs;

fiberglass-mesh filters, electrostatically charged filters, TRUE-HEPA filters, activated carbon charcoal filters, extended media filters, electronic filters with electric power supply 51, ultraviolet filters, ion filters custom designed filters and filter combinations.

The custom designed filters for the second group of multiple filter screens 28c, may be selected and combined from existing generic or non-generic filter designs, sized and constructed to comply with this invention's specifications.

The multiple filter screen surrounds 28d, consist of a structure for attaching and supporting the group of multiple filter screens 28b, & 28c, and are connected to the airflow filter assembly frame 28a.

The airflow filter assembly, hinges 28e, connects the multiple filter screen surrounds 28d, to the airflow filter assembly frame 28a and allows the first group of multiple filter screens 28b, and second group of multiple filter screens 28c, to be folded open for cleaning/replacement and folded to a closed position far inserting into the airflow filter assembly frame upper guide 29, and into the sloped floor of lower guide 32.

Additionally, illustrated is the moisture drip edge 49, located at the lower tip of the second airflow vane 38, allows returning condensate moisture derived from airflow exhaust pipe C, to drip downward into the sloped basin shelf 21, while preventing airflow 25, from entering the sloped basin shelf 21.

Additionally, illustrated is the second airflow directional vane 38, which turns the latterly flowing airflow 25, after flowing thru the removable airflow filter assembly 28, to an upward direction. Additionally illustrated is the sloped basin shelf 21, which is positioned to receive moisture from the removable airflow filter assembly 28, and from the moisture drip edge 49, and deliver the moisture to the returning moisture drain 22.

Additionally illustrated is the returning moisture drain 22, which receives moisture from sloped basin shelf 21, and delivers moisture into the returning moisture drain 22.

FIG. 8, illustrates a front view of an alternate bottom port within the housing 1, the airflow 25, travels thru the flexible airflow vent duct 17, into the alternate receiving airflow channel 26, directed by the first airflow directional vane 27, thru the removable airflow filter assembly 28, and directed by the alternate airflow directional vane 36, downward thru the alternate exhaust airflow channel 37, into the airflow exhaust pipe 45, exiting the substantially open lower compartment 2, and thru the alternate vent knockout 18.

FIG. 9, illustrates a front view of an alternate airflow exit port 50, within the housing 1, the airflow 25, travels thru the flexible airflow vent duct 17, into the alternate receiving airflow channel 26, directed by the first airflow directional vane 27, thru the removable airflow filter assembly 28, and directed by the alternate airflow directional vane 36, thru the alternate airflow exit port 50, located on a side of housing 1, into the airflow exhaust pipe 45, to the exterior.

Additionally, illustrated are the housing attachment flanges 9, and attachment holes of housing flanges 10, for securing the housing 1, to a wall system. Additionally, illustrated is the hinged barrier in open position 13, comprising hinged barrier adjustable cross bars 14, and hinged barrier hinges 15.

The hinged barrier in open position 13, allows access into the substantially open lower compartment 2, for efficient placement of the flexible airflow vent duct 17.

FIG. 10 illustrates a front view of the housing 1, with the substantially closed upper compartment 3, with the front wall of substantially closed upper compartment 11, installed.

The openable access openings 39, allow inspections, repairs and cleaning when not covered by the removable viewing windows 40, which when installed over the openable access openings 39, creates an airtight seal of the openable access openings 39.

Additionally illustrated is the substantially open lower compartment 2, with the flexible airflow vent duct 17, placed inside the substantially open lower compartment 2, secured by the hinged barrier in closed position 12.

Additionally illustrated is the moisture drain trap 23, connected to the moisture disposal hose 24, which extends outside of the substantially open lower compartment 2, to dispose returning condensate moisture derived from airflow exhaust pipe C.

Additionally illustrated is an airflow exhaust system comprising the airflow exhaust pipe 45, an extended airflow pipe to exterior atmosphere 45-1, an extended airflow pipe to interior HVAC Ductwork or dedicated duct system 45-2, additionally, including a Wye Diverter 45-3, and an Airflow damper 45-4.

The airflow exhaust system being substantially hollow comprising, an airflow exhaust pipe 45, extending from the housing 1, with a first end connected to the airflow exhaust pipe connector 43, and its second end connected to a first open receiving end of a hollow Wye Diverter 45-3, constructed with two additional outlet ends forked for providing two separate airflow exiting branches.

Additionally, the Wye Diverter 45-3, having a first open airflow receiving end and two separate airflow exiting ends, and a damper door within the Wye Diverter 45-3, for selecting one or another airflow exiting ends constructed for airflow passage, and the damper door within the Wye Diverter 45-3, constructed to block off one airflow exiting end, resulting in the other airflow exiting end to be in an open position for airflow 25, passage, and a hollow extended airflow pipe to the exterior atmosphere 45-1, constructed as a channel for carrying airflow 25, from the Wye Diverter 45-3, thru the building's exterior wall to the exterior, and a hollow extended airflow pipe to interior

HVAC Ductwork or dedicated duct system 45-2 constructed as a channel for carrying airflow 1, from the Wye Diverter 45-3, into the HVAC Ductwork.

Additionally, an airflow damper 45-4, located within the junction of the extended airflow pipe and HVAC Ductwork 45-2, constructed to regulate airflow within the HVAC Ductwork and within said extended airflow pipe to interior HVAC Ductwork 45-2, for preventing the HVAC airflow from entering the extended airflow pipe to interior HVAC Ductwork 45-2, during operational and non-operational periods of said airflow exhaust fan 46, located within the housing 1.

FIG. 11, illustrates a perspective view of the substantially open lower compartment 2, of the housing 1, with the flexible airflow vent duct 17, placed and secured by the hinged barrier in closed position 12, which is attached by the hinged barrier attachment 34.

Additionally, the hinged barrier in closed position 12, comprises the hinged barrier adjustable cross bars 14, and hinged barrier control mechanism 16, which moves the hinged barrier in closed position 12, and moves the hinged barrier in open position 13, to provide access to the substantially open lower compartment 2.

Additionally illustrated is the bottom wall of housing 4, vent knockouts, left, right, and bottom walls 18, and the moisture disposal hose 24.

Additionally, illustrated is the electrical wiring from control system to clothes dryer 56, coiled for future connection to the clothes dryer CD.

FIG. 12, illustrates an exploded view of removable airflow filter assembly 28, comprising of the following;

The moisture weep holes 28g, are located within the lower side of the airflow filter assembly frame 28a, of the removable airflow filter assembly 28, for receiving returning condensate moisture deriving from airflow exhaust pipe C, that may inadvertently flow back into the removable airflow filter assembly 28.

The first group of multiple filter screens 28b, comprising any or all or a combination of the following filter designs;

fiberglass-mesh filters, electrostatically charged filters, True-HEPA filters, activated carbon charcoal filters, extended media filters, electronic filters with electric power supply 51, ultraviolet filters, ion filters and custom designed filters and filter combinations.

The custom designed filters for the first group of multiple filter screens 28b, may be selected and combined from existing generic or non-generic filter designs, sized and constructed to comply with this invention's specifications.

The second group of multiple filter screens 28c, comprising any or all or a combination of the following filter designs;

fiberglass-mesh filters, electrostatically charged filters, True-HEPA filters, activated carbon charcoal filters, extended media filters, electronic filters with electric power supply 51, ultraviolet filters, ion filters and original custom designed filter combinations.

The custom designed filters for the second group of multiple filter screens 28c, may be selected and combined from existing filter designs or currently non-existing filter designs, custom designed filters are specified to comply with this invention's specifications.

The multiple filter screen surrounds 28d, consist of a structure for attaching and supporting the group of multiple filter screens 28b, & 28c, and are connected to the airflow filter assembly frame 28a.

The airflow filter assembly, hinges 28e, connects the multiple filter screen surrounds 28d, to the airflow filter assembly frame 28a and allows the first group of multiple filter screens 28b, and second group of multiple filter screens 28c, to be folded open for cleaning and replacement and folded to a closed position for inserting into the airflow filter assembly frame upper guide 29, and into the sloped floor of lower guide 32.

Additionally, airflow sensers 28f, which are attached to the airflow filter assembly frame 28a, for quality control and airflow condition monitoring within the removable airflow filter assembly 28 communicates with the control system 52, and monitor and alarm 52-1.

FIG. 13, illustrates a side view of airflow 25, exiting thru the building's exterior airflow exiting port 44, and thru the airflow exhaust pipe connector 43, into the airflow exhaust pipe 45, with returning condensate moisture derived from airflow exhaust pipe C, flowing downward.

The rotatable damper door 19-2, of the exiting airflow distribution device 42, is in the open position of rotatable damper door 44d, resulting in building's interior airflow exiting port 47, being closed.

The manual damper door control mechanism 44a, manually controls the rotatable damper door 19-2, and the damper door hinge 44b, is attached to the damper door 19-2 and to the front wall of substantially closed upper compartment 11.

Additionally, the manual damper door control mechanism 44a, operates the rotatable damper doors 19-2, within the receiving airflow distribution device 41, and within the exiting airflow distribution device 42.

Within the receiving airflow distribution device 41, airflow 25, can be received thru the clothes dryer airflow receiving port 19-1, or received thru the building's interior airflow receiving port 19-4, subject to positioning of the rotatable damper door 19-2, which is positioned either electrically or by the manual damper door control mechanism 44a.

Within the exiting airflow distribution device 42, airflow 25, can be expelled thru the building's interior airflow exiting port 47, or expelled thru the building's exterior airflow exiting port 44, subject to positioning of the rotatable damper door 19-2, which is positioned either manually or by the manual damper door control mechanism 44a.

FIG. 14, illustrates a side view of the substantially closed upper compartment 3, with the airflow 25, being blocked from entering the airflow exhaust pipe 45, and allowing airflow 25, to exit the buildings interior airflow exiting port 47, at the front of the exiting airflow distribution device 42. The closed position of rotatable damper door 44e, of rotatable damper door 19-2, within the exiting airflow distribution device 42, prevents airflow 25, from entering the airflow exhaust pipe 45, and directs the airflow 25, to exit thru the building's interior airflow exiting port 47. Additionally, illustrated is the damper door hinge 44b connected to the front wall of substantially closed upper compartment 11, and connected to the rotatable damper door 19-2 for rotation between the building's interior airflow exiting port 47, and building's exterior airflow exiting port 44.

Additionally, damper door air seal 44c, blocks air and water leakage when the rotatable damper door 19-2 is in a closed position.

FIG. 15, illustrates a side view of housing 1, adjacent to the clothes dryer CD, Illustrating the substantially open lower compartment 2, with the vent knockouts, left, right and bottom walls 18, and the substantially closed upper compartment floor/substantially open lower compartment ceiling 20, which separates the substantially open lower compartment 2, from the substantially closed upper compartment 3, and additionally serves to make the substantially closed upper compartment 3, airtight.

The substantially closed upper compartment 3, comprises a front wall of substantially closed upper compartment 11, comprises a top wall of housing 8, comprises a rear wall of housing 7, and comprising airflow exhaust pipe 45,

Additionally illustrated is an airflow exhaust system comprising the airflow exhaust pipe 45, an extended airflow pipe to exterior atmosphere 45-1, an extended airflow pipe to interior HVAC Ductwork or dedicated duct system 45-2, additionally, including a Wye Diverter 45-3, and an Airflow damper 45-4.

The airflow exhaust system being substantially hollow comprising, an airflow exhaust pipe 45, extending from the housing 1, with a first end connected to the airflow exhaust pipe connector 43, and its second end connected to a first open receiving end of a hollow Wye Diverter 45-3, constructed with two additional outlet ends forked for providing two separate airflow exiting branches.

Additionally, the Wye Diverter 45-3, having a first open airflow receiving end and two separate airflow exiting ends, and a damper door within the Wye Diverter 45-3, for selecting one or another airflow exiting ends constructed for airflow passage, and the damper door within the Wye Diverter 45-3, constructed to block off one airflow exiting end, resulting in the other airflow exiting end to be in an open position for airflow 25, passage, and a hollow extended airflow pipe to the exterior atmosphere 45-1, constructed as a channel for carrying airflow 25, from the Wye Diverter 45-3, thru the building's exterior wall to the exterior, and a hollow extended airflow pipe to interior HVAC Ductwork or dedicated duct system 45-2 constructed as a channel for carrying airflow 1, from the Wye Diverter 45-3, into the HVAC Ductwork.

Additionally, an airflow damper 45-4, located within the junction of the extended airflow pipe and HVAC Ductwork 45-2, constructed to regulate airflow within the HVAC Ductwork and within said extended airflow pipe to interior HVAC Ductwork 45-2, for preventing the HVAC airflow from entering the extended airflow pipe to interior HVAC Ductwork 45-2, during operational and non-operational periods of said airflow exhaust fan 46, located within the housing 1.

Additionally illustrated is the control system 52, communicating with the clothes dryer CD, thru the electrical wiring from control system to clothes dryer 56, for signaling emergency shutdown commands when warranted.

FIG. 16, illustrates a front view of an alternate design to serve a clothes dryer CD, stacked design with the airflow 25, derived from the clothes dryer CD, entering the substantially open lower compartment 2, thru the vent knockouts, left, right and bottom walls 18, and thru the airflow receiving adapter 19, into the substantially closed upper compartment 3.

Additionally illustrated are the removable airflow filter assembly 28, moisture drain channel 48, airflow exhaust pipe 45, first airflow directional vane 27, left wall of housing 5, right side of housing 6, returning moisture drain 22, control system 52.

FIG. 17, illustrates a side view of housing 1, in an alternate raised from the floor installation of the housing 1, in order to accommodate a taller clothes dryer pedestal design.

Illustrated is the relationship of the housing 1 to the pedestal design of the clothes dryer CD. Additionally, illustrated is the rear wall of housing 7, the front wall of substantially closed upper compartment 11, the substantially closed upper compartment floor/substantially open lower compartment ceiling 20, and the airflow exhaust pipe 45.

FIG. 18, illustrates a front view of a typical housing 1, configuration in relationship to a clothes washer and clothes dryer CD, additionally illustrated is the clothes washer drain.

The clothes washer drain accepts returning condensate moisture deriving from airflow exhaust pipe C, thru the moisture drain trap 23, and thru the moisture disposal hose 24.

Alternately, the moisture disposal hose 24, can be directly or indirectly connected to the Main Sewer Line for disposal.

Additionally, illustrated is the airflow exhaust pipe 45, for exiting airflow 25, from the housing 1. Additionally illustrated is an airflow exhaust system comprising the airflow exhaust pipe 45, an extended airflow pipe to exterior atmosphere 45-1, an extended airflow pipe to interior HVAC Ductwork or dedicated duct system 45-2, additionally, including a Wye Diverter 45-3, and an Airflow damper 45-4.

The airflow exhaust system being substantially hollow comprising, an airflow exhaust pipe 45, extending from the housing 1, with a first end connected to the airflow exhaust pipe connector 43, and its second end connected to a first open receiving end of a hollow Wye Diverter 45-3, constructed with two additional outlet ends forked for providing two separate airflow exiting branches.

Additionally, the Wye Diverter 45-3, having a first open airflow receiving end and two separate airflow exiting ends, and a damper door within the Wye Diverter 45-3, for selecting one or another airflow exiting ends constructed for airflow passage, and the damper door within the Wye Diverter 45-3, constructed to block off one airflow exiting end, resulting in the other airflow exiting end to be in an open position for airflow 25, passage, and a hollow extended airflow pipe to the exterior atmosphere 45-1, constructed as a channel for carrying airflow 25, from the Wye Diverter 45-3, thru the building's exterior wall to the exterior, and a hollow extended airflow pipe to interior HVAC Ductwork or dedicated duct system 45-2 constructed as a channel for carrying airflow 1, from the Wye Diverter 45-3, into the HVAC Ductwork.

Additionally, an airflow damper 45-4, located within the junction of the extended airflow pipe and HVAC Ductwork 45-2, constructed to regulate airflow within the HVAC Ductwork and within said extended airflow pipe to interior HVAC Ductwork 45-2, for preventing the HVAC airflow from entering the extended airflow pipe to interior HVAC Ductwork 45-2, during operational and non-operational periods of said airflow exhaust fan 46, located within the housing 1.

FIG. 19, illustrates a front view of housing 1, with an alternate fan placement of the airflow fan 46, located above and connected to the airflow exhaust pipe connector 43, and below and connected to the air flow exhaust pipe 45.

The alternate placement of airflow exhaust fan 46, located outside and above the housing 1, serves as an alternate fan location when a high volume/high velocity fan is required, such as in a commercial or industrial installation.

Additionally, illustrated is the front wall of substantially closed upper compartment 11, installed to cover the front wall of the substantially closed upper compartment 3.

Additionally, the front wall of substantially closed upper compartment 11, contains openings for the control system, 52, and removable airflow filter assembly 28, and receiving airflow distribution device 41, and exiting airflow distribution device 42, and openable access openings 39, and removable viewing windows 40.

Additionally, the control system 52, which is electrified to provide visual alerts and audible alerts of safety issues and airflow inefficiencies within the housing 1, including but not limited to airflow vent blockage, interior over-heating and filter blockage or a combination of each.

Additionally, the control system 52. Is located within the substantially closed upper compartment 52.

Additionally, within the substantially open lower compartment 2, is the flexible airflow vent duct 17, moisture drain trap 23, and moisture disposal hose 24, efficiently positioned and secured by the hinged barrier in closed position 12.

FIG. 20, illustrates the electrical control system 52;

comprising a monitor and alarm 52-1, for providing visual and recorded data and an alarm for audible notifications of emergency and abnormal conditions within the housing 1.

Additionally, a bank of switches, comprising a switch 52a, to activate ON/OFF electrical power supply to all components of the control system.

Additionally, a switch 52b, for activating airflow 25, to be received thru the clothes dryer airflow receiving port 19-1, and the same airflow 25, exiting thru the building's exterior airflow exiting port 44, to the exterior atmosphere.

Additionally, a switch 52c, for activating airflow 25, to be received thru the clothes dryer airflow receiving port 19-1, and the same airflow 25, exiting thru the building's interior airflow exiting port 47, into the building's interior as filtered airflow.

Additionally, a switch 52d, for activating airflow 25, to be received thru the building's interior airflow receiving port 19-4, and the same airflow 25, exiting thru the building's exterior airflow exiting port 44, to the exterior atmosphere.

Additionally, a switch 52e, for activating airflow 25 to be received thru the building's interior airflow receiving port 19-4, and the same airflow 25, exiting thru the building's interior airflow exiting port 47, to the building's interior as filtered airflow.

Additionally, blank switches for future addition 52f, for additional electrical circuit needs are provided in the electrical control system 52.

51 illustrates electrical power wired into the electrical control system 52, for powering electrical components within the housing 1.

53, illustrates electrical wiring for communicating from the control system 52, to the airflow exhaust fan 46.

54, illustrates electrical wiring for communicating from the electrical control system 52, to the receiving and exiting rotatable damper door actuators 19-3.

55, illustrates electrical wiring for communicating between the receiving rotatable damper door actuator 19-3, and the exiting rotatable damper door actuator 19-3.

56, illustrates electrical wiring for communicating between the control system 52, and the clothes dryer CD, for emergency shutdowns of the clothes dryer CD, when conditions warrant.

58, illustrates electrical wiring for communicating between the monitor and alarm 52-1, and the airflow sensors 28f.

59, illustrates electrical wiring for communicating between the control system 52, and the monitor and alarm 52-1.

60, illustrates electrical wiring for communicating between the control system 52, and the airflow sensers 28f.

### LIST OF PARTS

1. Housing.
2. Substantially open lower compartment.
3. Substantially closed upper compartment.
4. Bottom wall of housing.
5. Left side of housing.
6. Right side of housing.
7. Rear wall of housing.
8. Top wall of housing.
9. Housing attachment flanges.
10. Attachment holes of housing flanges.
11. Front wall of substantially closed upper compartment.
12. Hinged barrier in closed position.
13. hinged barrier in open position.
14. hinged barrier adjustable cross bars.
15. Barrier hinges.
16. Hinged barrier control mechanism.
17. Flexible airflow vent duct.
18. Vent knockouts, left, right and bottom walls.
19. Airflow receiving adapter.
19-1. Clothes dryer airflow receiving port.
19-2. Rotatable damper door.
19-3 Rotatable damper door actuator.
19-4. Building's interior airflow receiving port.
20. Substantially closed upper compartment floor/substantially open lower compartment ceiling.
21. Sloped basin shelf.
22. Returning moisture drain.
23. Moisture drain trap.
24. Moisture disposal hose.
25. Airflow.
26. lower airflow channel.
27. First airflow directional vane.
28. Removable airflow filter assembly.
28a. Airflow filter assembly frame.
28b. First group of multiple filter screens.
28c. Second group of multiple filter screens.
28d. Multiple filter screen surrounds.
28e. Airflow filter assembly hinges.
28f. Airflow sensers.
28g. Moisture weep holes.
29. Airflow filter assembly frame upper guide.
30. Frame of lower guide.
31. Sloped lower guide.
32. Sloped floor of lower guide.
33. Sloped frame bottom wall.
34. Hinged barrier attachment.
35. Airflow deflector.
36. Alternate airflow directional vane.
37. Exhaust airflow channel.
38. Second airflow directional vane.
39. Openable access openings.
40. Removable viewing windows.
41. Receiving airflow distribution device.
42. Exiting airflow distribution device.
43. Airflow exhaust pipe connector.
44. Building's exterior airflow exiting port.
44a. Manual damper door control mechanism.
44b. Damper door hinge.
44c. Damper door air seal.
44d. Open position of rotatable damper door.
44e. Closed position of retractable damper door.
45. Airflow exhaust pipe.
46. Airflow exhaust fan.
45-1. Extended airflow pipe to exterior atmosphere
45-2. Extended airflow pipe to interior HVAC Ductwork or dedicated duct system
45-3. Wye Diverter
45-4. Airflow Damper
46. Airflow exhaust fan
47. Building's interior airflow exiting port.
48. moisture drain channel.
49. moisture drip edge.
50. Alternate airflow exiting port.
51. Electrical power supply.
52. Electrical control system.
52-1. Monitor and alarm.
52a. Switch to activate On/Off electric power supply.
52b. Switch to activate said airflow received thru said clothes dryer airflow receiving port and said airflow exhausted thru said building's exterior airflow exiting port.
52c. Switch to activate said airflow received thru said clothes dryer airflow receiving port and said airflow exhausted thru said building' interior airflow exiting port as recycled airflow.
52d. Switch to activate said airflow received thru said building's interior airflow receiving port and said airflow exhausted thru said building's exterior airflow exiting port.
52e. Switch to activate said airflow received thru said building's interior airflow receiving port and said airflow exhausted thru said building's interior airflow exiting port as recycled airflow.
52f. Blank switches for future addition.
53. Electrical wiring from said control system to the airflow exhaust fan.
54. Electrical wiring from said control system to receiving and exiting rotatable damper door actuators.
55. Electrical wiring from receiving rotatable damper door actuator to exiting rotatable damper door actuator.
56. Electrical wiring from control system to clothes dryer.
57. Remote control.
58. Electrical wiring from monitor and alarm to airflow sensors.
59. Electrical wiring from the control system to monitor and alarm.
60. Electrical wiring from control system to airflow sensers.
C. Returning condensate moisture deriving from airflow exhaust pipe
CD. Clothes dryer.

### BACKGROUND

A typical clothes dryer works by forcing moist hot air with a degree of excess lint out into vent piping with no means of separating the moisture laden air from the excess lint, when the warm moist dryer air within the dryer vent reaches a space such as a garage, attic or outside atmosphere, colder temperatures cause the relative humid air to condense back to liquid form of water within the vent pipe.

This water can drain back into the clothes dryer or settle in a low point of the dryer vent causing blockage and overheating of the dryer, which can result in fire.

A full load of wet clothes can contain as much as 1.5 gallons of water, which can blend with lint and over time develop into a sludge within the vent causing blockage.

It has been estimated that there are about 2,900 clothes dryer related fires and 238 million in property loss per year.

This invention relates to solving this clothes dryer problem.

Additionally, there are no sensors within a clothes dryer vent system that communicates to shutdown a clothes dryer's electrical system when its vent piping becomes blocked, resulting in overheating and possible fires.

This invention relates to solving this clothes dryer problem.

Additionally, a typical clothes dryer vent pipe has no means to drain away the water derived from condensation within the vent pipe before it drains back down into the dryer's flexible vent or into the dryer itself.

This invention relates to solving this clothes dryer problem.

Additionally, a typical clothes dryer's placement tight to a wall causes the flexible vent to be crushed or kinked resulting in reduced airflow passage and trapped water in the deformed area of the flexible vent, causing blockage and overheating.

This invention relates to solving this clothes dryer problem.

Indoor pollution of a typical house is often 2 to 5 times higher than typical outdoor concentrations. Americans, on average, spend a great deal of their time indoors. People who are often susceptible to the adverse effects of pollution (e.g., the very young, older adults, people with cardiovascular or respiratory disease) tend to spend even more time indoors. The air exchange rate with the outdoors is an important factor in determining indoor air Pollutant concentrations.

Another effective way to improve indoor air quality are to reduce or remove the sources of pollutants and to ventilate with clean outdoor air or with recycled indoor air thru air cleaners and engineered filters designed for improving indoor air quality.

This invention relates to solving this indoor air-quality problem

Often indoor air quality issues have been addressed by placing portable air cleaners in the middle of a room or house, resulting an undesirable and unsightly addition to otherwise desirable room layouts.

This invention relates to solving this indoor air-quality problem

Another attempt to solving the indoor air quality problem has been to upgrade the air filter in the central-air furnace or central air-conditioning (HVAC) system.

Often, the heating/AC system operates only a percentage of the time in Winter and Summer and can be completely non-operational in the Fall and Spring when outside temperatures are mild, and heating and air-conditioning are not required.

This invention relates to solving this indoor air quality problem.

It is the belief that this invention can make a house better by addressing clothes dryer venting and safety problems, and by making the interior of a house healthier by improving the indoor air quality in an efficient manner.

### CONCLUSION, RAMIFICATIONS AND SCOPE

Accordingly, the reader will see that the housing can be of multiple sizes and shapes to engage with a verity of clothes dryer configurations, it can be free standing, inserted within building walls or elevated.

The control system, and its elements can be a component of a computer system and programed to operate as a smart airflow processing system.

An extended piping system communicating with the receiving ports and the exit ports for circulating airflow throughout the building when in the building's interior airflow circulation mode.

The airflow fan may be of current designs or of future designs to meet the specific design requirements of this invention.

The damper door actuators of this invention may also be of current design or of future designs to meet the specific design requirements of this invention.

The removable airflow filter assembly can have other airflow filtering and airflow cleaning components of different specifications to meet the filtering requirements, including but not limited to removing radon, mold, volatile organic compounds (VOC), natural and unnatural odors.

The removable airflow filter assembly may comprise filtration components for any air-carrying contamination currently known and any future air-carrying contamination not currently known. Although the descriptions above contain many specifications, these should not be construed as limiting the scope of the embodiments but as merely providing illustrations of some of the presently preferred embodiments.

Thus, the scope of embodiments should be determined by the appended claims and their legal equivalents, rather than by the examples given.

I claim:

1. A building's airflow and a clothes dryer's exhaust filtering and recycling system comprising an emergency shutdown element, condensate separation and multiple airflow receiving and discharging configurations comprising:
a housing;
comprising a multi-performance venting system within a housing for receiving airflow from said clothes dryer or for receiving airflow from a building's interior thru one or another receiving airflow ports within a receiving system; and
for exiting said airflow out thru an airflow exhaust pipe or for exiting said airflow into said building's interior thru one or another exiting airflow ports within an existing distribution system as filtered airflow; and
said airflow being moved thru said housing by a multi-performance airflow fan located within said housing constructed to be removable and replaceable within a holding pocket comprising releasable electrical wiring terminals and releasable holding brackets, and
a rotatable damper door within said receiving distribution system to either select said airflow from said clothes dryer or to select said airflow from said building's interior; and
a rotatable damper door within said exiting distribution system for selecting either exiting airflow out thru an airflow exhaust pipe system or for selecting said exiting airflow into said building's interior, as filtered airflow; and
a condensate separation system for preventing condensate from entering said clothes dryer, comprising a moisture drain channel communicating with said airflow exhaust piping constructed to intercept and drain away returning condensate moisture derived from airflow exhaust pipe into a moisture drain trap and continuing into a moisture disposal hose for disposal outside of said housing, said moisture drain channel, said moisture drain trap and said moisture disposal hose being connected to construct a continues hollow channel for removing condensate water from said housing, and
said condensate separation system constructed as a constant operational gravity system, not reliant on said airflow exhaust fan or electrical power; and
a removable airflow filter assembly comprising multiple filter screens and devices located within said housing for removing contaminate and particulate from said airflow originating from said clothes dryer or originating from said building's interior; and
said removable airflow filter assembly positioned to filter said airflow moved by said airflow exhaust fan thru said housing; and
said removable airflow filter assembly constructed to drain away water collected by said multiple filter screens, which may derive from condensate moisture; and
a multi-performance electrical control system comprising data processing circuitry connecting sensers, monitor and alarm, switches, actuators and remote control by electrical wiring circuitry or an electrical control loop for processing, suppling, recording and indicating performance data of internal operational conditions within said housing; and comprising switches for controlling said rotatable damper doors as directed by an operator thru said switches within said electrical control system; and
said electrical control system additionally, communicates thru electrical circuitry with said clothes dryer and said airflow exhaust fan to direct a safety shutdown of said clothes dryer and said airflow exhaust fan when critical or emergency conditions exist within said housing; and
said electrical control system comprising a direct communication with said clothes dryer and said airflow exhaust fan to deactivate mechanical activity when safety conditions arise within said housing; and
said housing comprising a substantially open lower compartment and a substantially closed upper compartment comprising openable access openings for access within said substantially closed upper compartment, and removable viewing windows constructed to cover said openable access openings for visual inspections within said substantially closed upper compartment; and
a flexible inlet pipe having a first open end connected to an exit port of said clothes dryer and a second open end connected to an inlet pipe adapter within said housing for conveying said airflow from said clothes dryer into said housing; and
an airflow exhaust system being substantially hollow comprising, an airflow exhaust pipe extending from said housing connected to the airflow exhaust pipe connector on a first end and connecting on its second end to a first open receiving end of a hollow Wye Diverter constructed with two additional outlet ends forked for providing two separate airflow exiting branches, and said Wye Diverter having a first open receiving port end and two separate airflow exiting port ends, and
a damper door within said Wye Diverter for selecting one or another exiting port ends constructed for airflow passage, and
said damper door within said Wye Diverter constructed to block off one exit port end resulting in the other exit port end to be in an open position for airflow; and
a hollow extended airflow pipe to the exterior atmosphere constructed as a channel for carrying airflow from said Wye Diverter thru the building's exterior wall to the exterior; and
a hollow extended airflow pipe to a HVAC Ductwork constructed as a channel for carrying airflow from said Wye Diverter into a HVAC Ductwork system or into an alternate exclusive distribution system; and
an airflow damper located within the junction of said extended airflow pipe and said HVAC Ductwork, constructed to regulate airflow within said HVAC Ductwork and within said extended airflow pipe for preventing HVAC airflow from entering said extended airflow pipe during non-operating periods of said airflow exhaust fan located within said housing.

2. The building's airflow and clothes dryer's exhaust airflow filtering and recycling system of claim 1 wherein:
said electrical control system within said housing, comprising circuitry, sensors, monitor and alarm, switches, actuators, and remote control for capturing and indicating data relating to airflow pressure, temperature, velocity and safety issues within said housing; and
said control system comprising said electrical control loop for activating said rotatable damper door for directing said airflow in thru one or another said airflow receiving ports and directing same said airflow out thru one or another said airflow exiting ports resulting in multiple airflow directional configurations; and
said control system comprising said electrical control loop for a shutdown function which communicates with said sensors and communicates with said clothes dryer to shutdown mechanical activity when safety conditions warrant a safety shutdown; and
said control system communicating with said airflow exhaust fan within said housing to shutdown mechanical activity, resulting in stoppage of mechanical activity of said clothes dryer and of said airflow exhaust fan resulting in deactivation of said airflow movement thru said housing; and
said control system comprising multiple switches within said control system for signaling said rotational damper doors to rotate for opening and closing said airflow receiving ports and for opening and closing said airflow exiting ports; and
a remote control device communicating with said control system for extended distance interaction by an operator; and
said removable airflow filter assembly comprising multiple filter screens and devices within frame structures for filtering said clothes dryer lint and for filtering said building's interior contaminated airflow, constructed for removing and disposing of contaminants; and
said removable airflow filter assembly comprising a first group of said multiple filter screens and a second group of said multiple filter screens for removing lint, particulate, airborne pollutants, molds, viruses, radon, VOC's, and odors from said building's interior and said clothes dryer; and
an airflow monitor and alarm, within said control system, constructed for indicating airflow conditions, volume and velocity within said housing, said airflow monitor and alarm comprising displays, probes and data storage constructed for indicating system conditions within said housing and providing notification of said system conditions, and
in combination having multiple airflow receiving ports and multiple airflow exiting ports having means by said control system for opening and closing said airflow receiving ports and said airflow exit ports individually or jointly for receiving said airflow thru one or another said airflow receiving ports and for exiting said airflow thru one or another said airflow exit ports; and
said airflow derived from said clothes dryer thru one said airflow receiving port and said airflow derived from a building's interior thru another said airflow receiving port; and
said airflow exiting thru one said airflow exit port to the outside atmosphere and said airflow exiting thru another said airflow exit port back into said building's interior as filtered clean recycled airflow; and
said rotatable damper door within said receiving distribution device functions to close off one or another said airflow receiving port while rendering the other said airflow receiving port in an open position, and
said rotatable damper door within an exiting distribution device functions to close off one or another said airflow exit port while rendering the other said airflow exit port in an open position; and
said condensate separation system comprising a moisture drain channel communicating with an exhaust airflow channel for intercepting returning condensate moisture derived from said exhaust pipe within said housing, and
said moisture drain channel constructed as a hollow tube for draining away said returning condensate moisture derived from said exhaust pipe and from said removable airflow filter assembly within said housing and preventing said returning condensate moisture derived from said exhaust pipe from entering a flexible airflow vent duct and from entering said clothes dryer; and
said airflow exhaust fan within said housing constructed for moving said airflow from said flexible inlet pipe in thru one or the other said airflow receiving ports and moving said airflow thru said removable airflow filter assembly and moving said airflow out thru one or the other said airflow exit ports within said housing; and
said airflow exhaust fan communicating with said control system as part of said control system for on-off activation and emergency shutdown of said airflow exhaust fan when internal conditions warrant; and
said airflow exhaust fan constructed for moving said airflow into said housing, thru said housing and out of said housing as directed by said control system; and
said airflow exhaust fan constructed for multiple speeds, powered by electrical current and constructed as a module unit for removal and replacement into a receiving pocket within said housing and constructed to be removable and replaceable within a holding pocket comprising releasable electrical wiring terminals and releasable holding brackets; and
said removable airflow filter assembly positioned for filtering and removing particulate and contaminates from said airflow, comprising multiple filtration screens and devices for filtering said airflow within said housing; and
individual filtration screens of said removable airflow filter assembly constructed for providing airflow filtration as an individual filtration screen or in conjunction with other individual filtration screens of said removable airflow filter assembly within said housing; and
a moisture drain channel receiving condensate water from said exhaust pipe within said housing constructed to capture and drain away water derived from condensate from flowing back down into said housing and flowing into said flexible airflow vent duct and flowing into said clothes dryer; and
said moisture drain channel comprising a hollow tube communicating with said airflow exhaust pipe, positioned to intercept said returning condensate moisture deriving from airflow exhaust pipe.

3. The building's airflow and clothes dryer's exhaust airflow filtering and recycling system of claim 1 wherein:
a substantially open lower compartment, comprising a hinged barrier constructed for securing and positioning said flexible airflow vent pipe comprising a first open end connected to said clothes dryer exit port and a second open end connected to an airflow receiving adapter within said housing and constructed for conveying exhaust airflow from said clothes dryer into said airflow receiving adapter comprising a substantially hollow interior; and
said substantially open lower compartment comprising a moisture drain trap for blocking entry of sewer gasses into said housing and a moisture disposal hose for draining away water derived from said moisture drain channel; and
said substantially open lower compartment combined with a hinged barrier constructed to efficiently contain and secure said flexible airflow vent duct within said substantially open lower compartment for rendering said flexible airflow vent duct to be protected and virtually crush-proof from improper placement of said clothes dryer, and
a substantially closed upper compartment constructed to position operational components for efficient accessibility and function, said operational components comprising said control systems, said removable airflow filter assembly, said airflow exhaust fan, said multiple airflow receiving ports, said multiple airflow exiting ports, said damper doors, said receiving airflow distribution device, said exiting airflow distribution device, and openable access openings and removable viewing window; and
said substantially closed upper compartment constructed to be extended above said clothes dryer in a typical installation behind said clothes dryer.

4. The building's airflow and clothes dryer's exhaust airflow filtering and recycling system of claim 1 wherein:
said housing comprises two side walls, a rear wall, a bottom wall, top wall and said substantially closed upper compartment front wall; and
said housing constructed to having said substantially open lower compartment, and substantially closed upper compartment; and
said housing may comprise a width of less than 15.5 inches and a depth of said substantially open lower compartment of less than 6 inches and a depth of said substantially closed upper compartment of less than 36 inches with the said substantially closed upper compartment designed to extend outward over said clothes dryer; and
said housing constructed to be free standing adjacent to a clothes dryer or preferably installed within the studs of a typical wall system to the rear of said clothes dryer; and
said housing having said walls with flanges and attachment holes for attaching said housing to a typical stud wall system; and
said housing and components of said housing are manufactured of substantially fire resistant materials.

5. The building's airflow and clothes dryer's exhaust airflow filtering and recycling system of claim 1, wherein:
said control system comprising said monitor and alarm for providing data of internal conditions of said housing, constructed for audible and visual notification of normal and abnormal conditions within said housing; and
comprising said switches within said control system constructed for sending electrical signals to said actuators constructed for operating said rotatable damper doors located within said receiving airflow distribution device and located within said exiting airflow distribution device, and
for said rotatable damper door to rotate for channeling said airflow in thru said clothes dryer airflow receiving port or for channeling said airflow in thru said building's interior airflow receiving port, and
for said rotatable damper door to rotate for channeling said airflow out thru said building's exterior airflow exiting port or for channeling said airflow out thru said building's interior airflow exiting port resulting in four (4) configurations of said airflow movement thru said housing; and
within said control system, an ON/OFF switch constructed for activating and deactivating said airflow exhaust fan located within said housing; and
said sensors within said housing constructed for detecting conditions and changes in conditions of the internal environment of said housing and for relaying electrical signals of said conditions to said control system and to said monitor and alarm; and
said control system relays electrical signals received from said sensors to said clothes dryer to activate a shutdown command of said clothes dryer when said conditions warrant; and
said control system relays electrical signals received from said sensors to said airflow exhaust fan to activate a shutdown command of said airflow exhaust fan when said conditions warrant; and
an electrical power supply from outside sources communicate with said airflow exhaust fan and said control system to meet electrical requirements of all components within said housing.

6. The building's airflow and clothes dryer's exhaust airflow filtering and recycling system of claim 1 wherein:
said control system comprising a monitor and alarm, for providing visual and recorded data and an alarm for audible notifications of abnormal conditions within said housing;
additionally, a group of switches, comprising a switch to activate ON/OFF electrical power supply to all components of the control system;
additionally, another switch for activating said airflow to be received thru said clothes dryer airflow receiving port and same airflow exiting thru said building's exterior airflow exiting port to the exterior atmosphere,
additionally, another switch for activating said airflow to be received thru said clothes dryer airflow receiving port and same airflow exiting thru said building's interior airflow exiting port as filtered airflow,
additionally, another switch for activating said airflow to be received thru said building's interior airflow receiving port and the same airflow exiting thru said building's exterior airflow exiting port,
additionally, another switch for activating said airflow to be received thru said building's interior airflow receiving port and the same airflow exiting thru said building's interior airflow exit port as filtered airflow, additionally, another switch for activating said wye diverter,
connected to said exhaust pipe, to direct said airflow thru a first exhaust branch to the outside atmosphere or to direct said airflow thru a second exhaust branch to the HVAC Ductwork or dedicated pipe for distribution of recycled airflow,
and
included are multiple spare switches for additional electrical circuitry needs are provided for future functions.
said airflow exhaust fan communicates with said control system thru said electrical circuitry and said rotatable damper door actuators communicates with said control system thru said electrical circuitry; and
said receiving port rotatable damper door actuator communicates with said exiting port rotatable damper door actuator thru said electrical circuitry, and
said clothes dryer communicates with said control system thru said electrical circuitry for communicating said clothes dryer shutdown signal from said control system when safety conditions warrant, and
said monitor and alarm communicates with said airflow sensers thru said electrical circuitry, and
said control system, which communicates with said monitor and alarm thru said electrical circuitry and said control system, which communicates with said airflow sensers, thru said electrical circuitry.

7. The building's airflow and clothes dryer's exhaust airflow filtering and recycling system of claim 1 wherein:
said removable airflow filter assembly within said housing constructed for removing and disposing of particulate and contaminates received from either said clothes dryer or from said building's interior; and
said removable airflow filter assembly comprising a first group of multiple filter screens and a second group of multiple filter screens constructed within multiple filter screen surrounds with hinges to open to 180 degrees open configuration when removed from said housing for cleaning, and said first group of multiple filter screens and second group of multiple filter screens constructed to be folded together for a closed configuration for inserting into a pocket within said housing; and said removable airflow filter assembly comprising multiple filter screens comprising means for removing multiple forms of contaminates, pollutants and particulate deriving from said building's interior and from said clothes dryer exhaust; and
said removable airflow filter assembly constructed to receive contaminated airflow and expel clean filtered airflow either to said building's exterior airflow exiting port or to said building's interior airflow exiting port.

8. The building's airflow and clothes dryer's exhaust airflow filtering and recycling system of claim 1 wherein:
said receiving distribution device comprising said clothes dryer airflow receiving port for receiving said airflow from a receiving airflow channel within said housing, which is derived from said clothes dryer delivered thru said flexible airflow vent duct thru said clothes dryer airflow receiving port into said receiving distribution device, into said removable airflow filter assembly for filtration; and
said building's interior airflow receiving port for receiving said airflow from said building's interior into said receiving distribution device, into said removable airflow filter assembly for filtration; and
said rotatable damper door hinged between said clothes dryer airflow receiving port and said building's interior airflow receiving port within said receiving distribution device hinged to rotate to closing off one or another airflow ports, thus, allowing said airflow passage thru one or the other open port within said receiving airflow distribution device, and
said rotatable damper door hinged between said building's interior airflow exiting port and said building's exterior airflow exiting port within said exiting airflow distribution device hinged to rotate to closing off one or another airflow ports, thus allowing said airflow passage thru one or the other open port within said exiting airflow distribution device.

9. The building's airflow and clothes dryer's exhaust airflow filtering and recycling system of claim 1 wherein:
said housing comprises said airflow exhaust system, constructed to be in a constant upward slope or a constant downward slope to prevent unintentional water accumulation resulting in airflow blockage in low points within said airflow exhaust system; and
said exhaust airflow system constructed and sized to accommodate total airflow volume delivered from said clothes dryer resulting in a nonrestrictive airflow passage thru said housing and said airflow exhaust system; and
components of said housing and said exhaust system constructed to accommodate at least 100 percent of said airflow capacity generated by said clothes dryer for providing unrestrictive airflow passage; and
said airflow exhaust system being substantially hollow comprising, an airflow exhaust pipe extending from said housing on a first end and connecting on its second end to a first open receiving port end of a hollow Wye Diverter constructed with two outlet port ends forked for providing two separate airflow exiting branches, and
said Wye Diverter having a first open receiving port end and two separate airflow exiting port ends, and
a damper door within said Wye Diverter for selecting one or another exiting port ends constructed for airflow passage, and
said damper door within said Wye Diverter constructed to block off one exit port end resulting in the other exit port end to be in an open position for airflow: and
a hollow extended airflow pipe to the exterior atmosphere constructed as a channel for carrying airflow from said Wye Diverter thru the building's exterior wall to the exterior atmosphere; and
a hollow extended airflow pipe to a HVAC Ductwork or alternate piping system, constructed as a channel for carrying airflow from said Wye Diverter into a HVAC Ductwork system or into said alternate piping system; and
an airflow damper located within the junction of said extended airflow pipe and said HVAC Ductwork, constructed to regulate airflow within said HVAC Ductwork and within said extended airflow pipe, and for preventing HVAC airflow from entering said extended airflow pipe during non-operating periods of said airflow exhaust fan located within said housing.

10. The building's airflow and clothes dryers exhaust airflow filtering and recycling system of claim 1 wherein:
The airflow exhaust fan, constructed as a modular unit for efficient removal from and replacement into a designated pocket within said housing constructed as a self-contained module for non-evasive detachment from said designated pocket and said airflow exhaust fan constructed to be a replaceable component of said housing; and
said airflow exhaust fan constructed to communicate with said electrical control system for receiving operational commands comprising, ON/OFF signals and emergency shutdown signals as part of said control system within said housing.
